(19) United States
(12) Patent Application Publication
(10) Pub. No.: US 2025/0378676 A1
(43) Pub. Date: Dec. 11, 2025

(54) Computer Vision Component For Product Identification

(71) Applicant: 365 Retail Markets, LLC, Troy, MI (US)

(72) Inventors: Ryan McWhirter, Saint Clair Shores, MI (US); Himanshu Vajaria, Cary, NC (US)

(21) Appl. No.: 18/740,405

(22) Filed: Jun. 11, 2024

(51) Int. Cl. G06V 10/764; G06Q 10/087; G06V 10/778

(52) U.S. Cl. CPC G06V 10/764; G06Q 10/087; G06V 10/778

(57) ABSTRACT

An imaging device associated with a picking station for inventory order fulfillment obtains first image data corresponding to a first product item having a product type. A computer vision component generates, using the first image data, a computer vision component associated with at the product type. Generating the computer vision component may include training a computer vision model using at least the first image data and a product type identifier corresponding to the product type. The computer vision component may be provided for use with a merchandiser device. The computer vision component may be configured to facilitate, based on second image data, identification of a second product item having the product type.

### TECHNICAL FIELD

This disclosure relates to a computer vision component for self-service market environments.

### BACKGROUND

Merchandiser devices are commonly found in retail environments and used to store product inventory while awaiting purchase. Products available in a merchandiser device may be provided to the merchandiser device from a packing warehouse at which inventory orders are processed. A customer may retrieve one or more products stored within a merchandiser device as part of a process for purchasing those one or more products. Similarly, a customer may replace one or more products within a merchandiser device where they decide against purchasing those one or more products. Inventories of products stored within a merchandiser device may be monitored to ensure product availability for customers.

### SUMMARY

Disclosed herein are, inter alia, implementations of systems and techniques for using computer vision for product identification in association with a self-service retail market environment.

Some implementations described herein relate to an apparatus for using computer vision for product identification in association with a self-service retail market environment. The apparatus includes a processing system that includes one or more memories and one or more processors coupled with the one or more memories. The processing system may be configured to cause the apparatus to obtain, via an imaging device associated with a picking station for inventory order fulfillment, first image data corresponding to a first product item having a product type. The processing system may be further configured to cause the apparatus to determine, in association with the picking station, the product type. The processing system may be further configured to cause the apparatus to generate, using at least the first image data, a computer vision component associated with at least the product type. The processing system, to cause the apparatus to generate the computer vision component, may be configured to cause the apparatus to train a computer vision model using at least the first image data and a product type identifier corresponding to the product type. The processing system may be further configured to cause the apparatus to provide the computer vision component for use with a merchandiser device, wherein the computer vision component is configured to facilitate, based on second image data, identification of a second product item having the product type.

Some implementations described herein relate to a method for using computer vision for product identification in association with a self-service retail market environment. The method may include obtaining, via an imaging device associated with a picking station for inventory order fulfillment, first image data corresponding to a first product item having a product type. The method may further include generating, using at least the first image data, a computer vision component associated with at least the product type. Generating the computer vision component may include training a computer vision model using at least the first image data and a product type identifier corresponding to the product type.

Some implementations described herein relate to a merchandiser device for using computer vision for product identification in association with a self-service retail market environment. The merchandiser device may include a processing system that includes one or more memories and one or more processors coupled with the one or more memories. The processing system may be configured to cause the merchandiser device to obtain a computer vision component. The computer vision component may be based on a computer vision model trained using first image data associated with a bin-packing operation in which a first product item, having a product type, is removed from a picking station and placed in a stocking bin associated with the self-service retail market environment. The first image data may correspond to one or more images of a packer holding the first product item. The processing system may be further configured to cause the merchandiser device to obtain, via a merchandiser imaging device comprising at least one merchandiser camera, second image data associated with a second product item. The processing system may be further configured to cause the merchandiser device to determine, using the computer vision component and based at least in part on the second image data, that the second product item has the product type. The processing system may be further configured to cause the merchandiser device to facilitate a product transaction operation based on determining that the second product item has the product type.

Implementations generally include a method, apparatus, system, computer program product, non-transitory computer-readable medium, computing device, network node, network entity, or processing system as substantially described with reference to and as illustrated by the drawings and specification.

The foregoing has outlined rather broadly the features of implementations in accordance with the disclosure in order that the detailed description that follows may be better understood. Additional features will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, will be better understood from the following description when considered in connection with the accompanying figures. Each of the figures is provided for the purposes of illustration and description, and not as a definition of the limits of the claims.

### BRIEF DESCRIPTION OF THE DRAWINGS

This disclosure is best understood from the following detailed description when read in conjunction with the accompanying drawings, which illustrate some aspects of the disclosure, but are not limiting of the scope of the disclosure because the description may enable other aspects in addition to, or in lieu of, those depicted in the drawings. Each of the drawings is provided for purposes of illustration and clarity of description, and not as a definition of the scope of any of the claims. It is emphasized that, according to common practice, the various features of the drawings are not to-scale. On the contrary, the dimensions of the various features are arbitrarily expanded or reduced for clarity.

FIG. 1 is a block diagram of an example of a self-service retail market system in accordance with the present disclosure.

FIG. 2 is a block diagram of an example of an internal configuration of a computing device of a self-service retail market system in accordance with the present disclosure.

FIG. 3 is a block diagram illustrating an example of a self-service retail market system in accordance with the present disclosure.

FIG. 4A is a schematic block diagram illustrating operations of an example of a self-service retail market system in accordance with the present disclosure.

FIG. 4B is a schematic block diagram illustrating operations of another example of a self-service retail market system in accordance with the present disclosure.

FIG. 5 is a flowchart illustrating a first example of a technique for using computer vision for product identification in association with a self-service retail market environment.

FIG. 6 is a flowchart illustrating a second example of a technique for using computer vision for product identification in association with a self-service retail market environment.

FIG. 7 is a flowchart illustrating an example of a technique for using computer vision for product identification in association with a product transaction at a self-service retail market environment.

### DETAILED DESCRIPTION

Shopping in a conventional brick and mortar retail store, such as a grocery or convenience store, involves shoppers retrieving products from various units (e.g., shelves, cabinets, or refrigerators), placing those retrieved products into a cart or basket, and ultimately initiating and completing a transaction to purchase those retrieved products at either a human-operated or self-service checkout area. A shopper is a user of a self-service retail market environment. In some cases, inventory records associated with the purchased products can be updated based on the completion of such a transaction. Units at the store are manually monitored from time to time by workers to restock product inventory on an as-needed basis and to ensure that products are not misplaced in the wrong units.

While brick and mortar retail shopping experiences have certain benefits, they also suffer from several substantial drawbacks, including that they are often inconvenient for shoppers who must wait in long checkout lines to complete a purchase transaction and that their operation generally requires a non-trivial number of human workers. One solution to these drawbacks is by way of a self-service market, which allows shoppers to conveniently purchase products directly from their personal devices or from kiosk devices without waiting in checkout lines and which can be operated without requiring human workers to continuously be present. Information associated with purchase transactions may be communicated to a device of a human operator who, on an as-needed basis, can restock the various units within the self-service market.

With the increasing popularity of self-service markets, attempts are being made to implement systems for improving the convenience of the self-service market experience for a shopper through automation. One particular approach to such automations includes using sophisticated systems of cameras to track shopper activity throughout a self-service market area, including to recognize products being retrieved from market units by a shopper. For example, such a self-service market may include some number of cameras disposed on a ceiling thereof and along various other surfaces to determine when a person retrieves a product from a shelf and to identify what that product is. One automation deployed in such a setting includes using the images captured by the camera system to automatically charge an account of the shopper an amount associated with the cost of a retrieved product, with the goal being saving the shopper more time by relieving the shopper of having to use their personal device or a kiosk device to complete a transaction.

In some approaches, shopper of the self-service market environment may interact with a transaction control device (e.g., of a merchandiser device) to perform a transaction to purchase a product (e.g. a consumable good, such as a food or beverage item, or a non-consumable good, such as headphones or a magazine). For example, the transaction may include a retail transaction in which the shopper provides a payment in exchange for the product. A transaction may be facilitated using input obtained from the shopper directly at a transaction control device or at a user device, such as a mobile device, of the shopper requesting the transaction. In some examples, application software running on the user device may establish wireless communication with application software running on the transaction control device. The established wireless communication may then be used for the transaction. For example, the wireless communication between the user device and the transaction control device may be used to provide user input indicative of payment information usable to complete a self-service market transaction. Identification of the product associated with the transaction may be accomplished using a camera disposed at the transaction control device.

However, these approaches suffer from drawbacks in at least some situations. For example, such camera-based approaches when implemented in a merchandiser device (e.g., a refrigerated unit or a non-refrigerated unit, such as a cabinet or cooler) may fail to accurately determine which product has been retrieved therefrom. As a consequence of such a failure, an account of a shopper may be improperly charged, or the system may entirely fail to charge the account. In some cases

Various implementations of the present disclosure addressing problems such as these relate generally to self-service market environments. Some implementations more specifically relate to using computer vision for product identification in association with self-service retail market environments. The computer vision may be implemented in the form of a computer vision component. A computer vision component may include hardware and/or software configured to facilitate implementation of an operation associated with a computer vision model. A computer vision model may include, for example, an artificial intelligence (AI) model. The AI model may include a machine learning model such as, for example, a neural network or a classifier. A computer vision component may include any number of computer vision models (e.g., general computer vision models, localized computer vision models, and/or a combination thereof). Thus, a computer vision component may include a data set associated with one or more computer vision models, a parameter set associated with one or more computer vision models, one or more computer vision models, one or more algorithms configured to be executed in association with one or more computer vision models, and/or an instantiation of a computer vision application (e.g., a client application that corresponds to a server application), among other examples.

In some implementations, the computer vision component may be generated using a product event manager. A product event manager may include hardware, software, or a combination of hardware and software, configured to generate a computer vision component. A product event manager may be, include, or be included in, a computing device associated with a warehouse. In this way, the computer vision component may be generated based on observations of activities at the warehouse. For example, the product event manager may obtain first image data corresponding to a first product item having a product type. The product event manager may obtain the first image data via an imaging device associated with a picking station for inventory order fulfillment. The first image data may be associated with a bin-packing operation in which the first product item is removed from a storage component of the picking station and placed in a stocking bin associated with the self-service retail market environment. The first image data may correspond to one or more images of a packer holding the first product item. For example, the first image data may include a digital representation of the one or more images and/or data indicative of one or more attributes of the one or more images.

The product event manager may determine the product type. For example, the product event manager may determine the product type in association with the picking station. In some examples, product event manager may determine the product type based on labeling data indicative of a product type identifier corresponding to the product type. In some examples, the labeling data may include the product type identifier. In some other examples, the labeling data may include data based on which the product type identifier may be determined. For example, the labeling data may include a storage component identifier corresponding to a storage component of the picking station from which the first product item is removed. The product event manager may identify the product type identifier based on a database that includes a stored indication of an association between the storage component identifier and the product type identifier.

The product event manager may generate, using at least the first image data, a computer vision component associated with at least the product type. For example, the product event manager may train a computer vision model using at least the first image data and a product type identifier corresponding to the product type. The product event manager may provide the computer vision component for use with a merchandiser device. The merchandiser device may obtain second image data associated with a second product item that a shopper of the self-service market environment has removed from a storage assembly. The product event manager may determine, using the computer vision component and based on the second image data, a product type associated with the second product item. In some implementations, at the warehouse, products may be packed for a retail market environment by a packer, which may be a human that removes products from storage components of a picking station and places the removed products in a stocking bin associated with the self-service retail market environment. Thus, one or more imaging devices (e.g., cameras) may be disposed within the warehouse in association with the picking station to obtain image data associated with the packer removing product items from storage components of the picking station, which may be a situation similar to a consumer removing the product item (at a later time) from a storage assembly in a self-service retail market environment. In this way, some implementations facilitate training computer vision models based on image data (e.g., training data) that is similar to image data that will be input to the resulting computer vision component to facilitate identification, based on the computer vision component, of one or more product items selected by a shopper in the self-service retail market environment. As a result, some examples of the present disclosure may facilitate more accurate and/or efficient training of computer vision models for product identification.

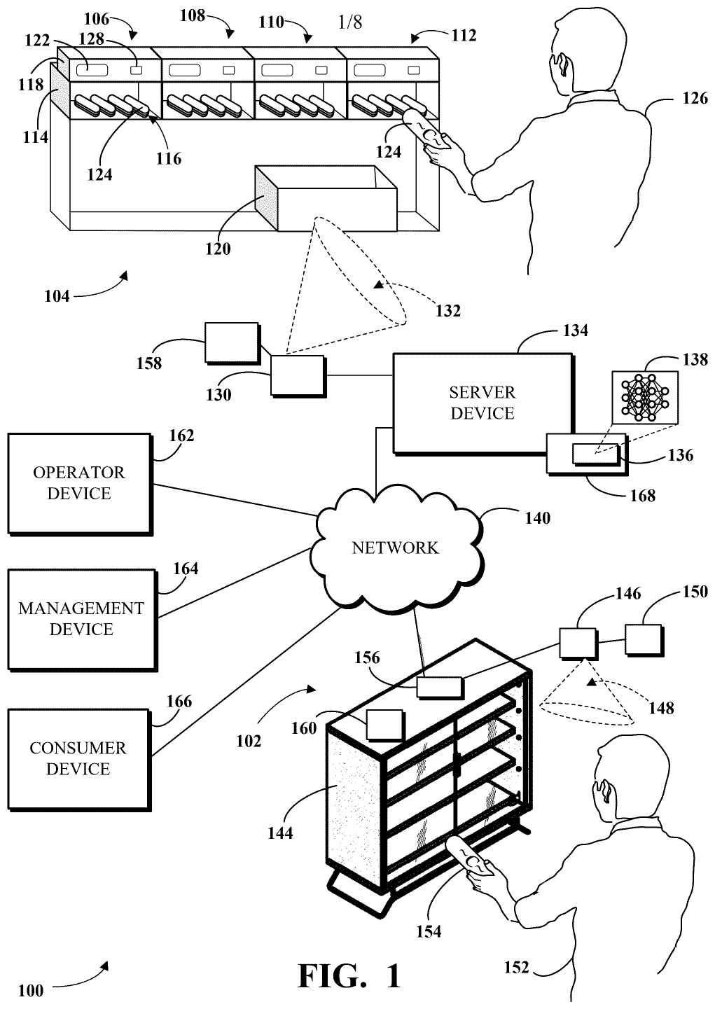

To describe some implementations in greater detail, reference is first made to examples of hardware structures which may be used. FIG. 1 is a block diagram of an example of a self-service retail market system 100. The system 100 includes a merchandiser device 102 that stores merchandise available for retail sale in a self-service retail market environment. The system 100 also includes a picking station 104. A picking station 104 is a system and/or assembly that includes one or more components configured to facilitate fulfilling an inventory order for providing inventory to a self-service retail market environment and/or to one or more specific merchandiser devices 102 associated with the self-service retail market environment. The picking station 104 may be implemented at any number of different locations associated with the self-service retail market system 100. The picking station 104 may be at a same location as one or more merchandiser devices 102 and/or at a different location from the one or more merchandiser devices 102. The picking station 104 may be at one location while one or more merchandiser devices 102 may be at one or more different locations. For example, the picking station 104 may be implemented at a warehouse associated with the self-service retail market system 100, and the merchandiser device 102 may be located at a self-service retail market environment (e.g., a retail store, a retail stand, a mall, an airport, etc.).

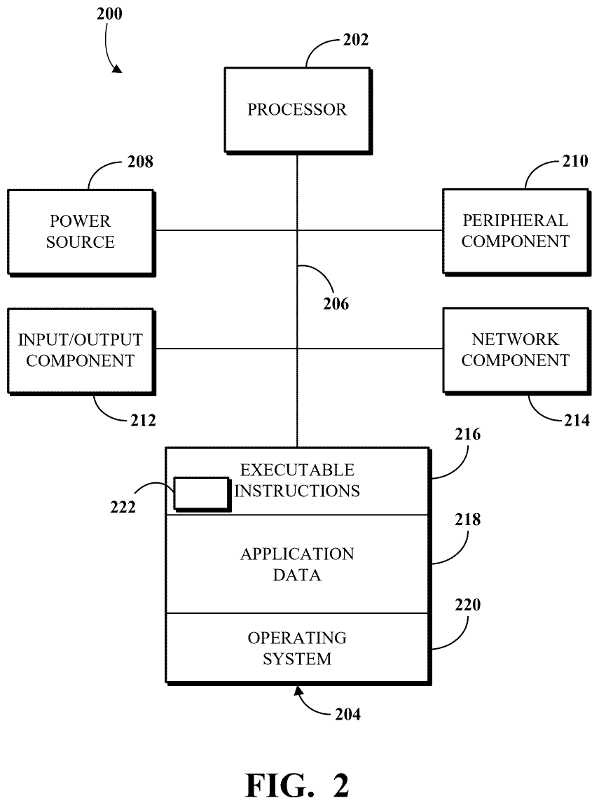

A picking station 104 includes one or more picking components 106, 108, 110, and 112. A picking component 106 includes a storage compartment 114 configured to hold a set 116 of product items. A set 116 of product items may include one or more product items. The picking component 106 also may include a picking controller 118. A picking controller 118 may include a device associated with the storage compartment 114. The picking controller 118 may include hardware and/or software configured to facilitate access to the storage compartment 114, to monitor access to the storage compartment 114, to track contents of the storage compartment 114, and/or to facilitate any aspect of a bin-packing operation in which one or more product items are removed from the storage compartment 114 and placed into a stocking bin 120. The picking controller 118 may be, include, or be included in, a computing device (such as, for example, the computing device 200 described below in connection with FIG. 2).

The picking controller 118 may include an output device 122 that may provide information associated with a bin-packing operation. For example, the output device 122 may display a representation indicative of a quantity of product items having a product type corresponding to the picking component 106 that are to be removed from the storage compartment 114 and placed in the stocking bin 120 for a bin-packing operation. In some examples, the picking component 106 may include one or more sensors configured to detect a removal of a product item 124 of the set 116 of product items from the storage compartment 114. In response to detecting the removal of the product item 124, the picking controller 118 may cause the output device 122 to display a quantity that is one less than a previously displayed quantity. For example, in operation, the output device 122 may display a representation indicative of a first quantity. A packer 126 (a user of the picking station 104) may remove the product item 124 from the storage compartment 114 and place the product item 124 in the stocking bin 120. In some examples, the picking controller 118 may detect the removal of the product item 124 and, responsive to that detection, may cause the output device 122 to display a representation indicative of a second quantity that is one less than the first quantity. The packer 126 may continue to remove product items 124 from the storage compartment 114 until the output device 122 displays a representation indicative of a quantity of zero. In some examples, the picking controller 118 may include an input device 128 (e.g., a button, a switch, a lever, a touchscreen, and/or any other input device capable of receiving an input from a packer 126). The input may be indicative of an occurrence of retrieval, by a packer 126, of a product item 124. In such cases, for example, the packer 126 may remove the product item 124 from the storage compartment 114 and interact with the input device 128 (e.g., press a button). The interaction with the input device 128 may cause the input device 128 to determine that a product item 124 has been removed from the storage compartment 114. In some examples, responsive to the interaction, the picking controller 118 may cause the output device 122 to display a representation indicative of a second quantity that is one less than the first quantity. In some examples, a picking component 106 may include one or more sensors configured to detect a removal, from the storage compartment 114, of a product item 124.

As shown, an imaging device 130 may be associated with the picking station 104. The imaging device 130 may refer to any number of different imaging devices. The imaging device 130 may be a camera (e.g., a digital camera and/or a video camera). Because the imaging device 130 may be disposed in a warehouse, the imaging device 130 may include a warehouse camera. The imaging device 130 may be configured to obtain first image data. The first image data may correspond to a first product item 124 and may be associated with a field of view 132 of the imaging device 130. The field of view 132 may be based on any number of different attributes of the imaging device 130 such as, for example, an aperture value, an exposure time, an orientation of the imaging device 130, a focus value of an automatic focusing assembly of the imaging device 130, a lens property, an illumination value, an orientation of an illumination device associated with the imaging device 130, or a sampling parameter, among other examples. In some cases, for example, the imaging device 130 may be configured to obtain image data responsive to detection of a user 126 in a vicinity of the picking station 104. In this way, the imaging device 130 may be configured to obtain image data that includes an image of the user 126 holding a product item 124.

In some implementations, the system 100 may include a server device 134. The server device 134 may represent one or more server devices, one or more server instances, and/or one or more virtual servers, among other examples. The server device 134 may include a processing system that includes one or more memories and one or more processors coupled with the one or more memories. The server device 134 may be communicatively coupled to the imaging device 130 and may be configured to obtain image data from the imaging device 130. The processing system may be configured to cause the server device 134 to generate a computer vision component 136 based at least in part on the image data. The computer vision component 136 may generated by training one or more computer vision models 138.

The one or more computer vision models 138 may be trained using image data obtained via the imaging device 130. In some implementations, one or more imaging devices (e.g., one or more cameras and/or video cameras) associated with the picking station 104 and oriented so that image data obtained by the one or more imaging devices may be likely to include information useful for training the one or more computer vision models 138. For example, because a packer 126 packs the stocking bin 120 by retrieving a product item 124 from the picking station 104 and placing the product item 124 in a stocking bin 120, image data may be obtained that includes images of the packer 126 retrieving and/or holding the product item 124. In this way, one or more computer vision models 138 may be trained using data associated with a scenario that is similar to a scenario that the computer vision component 136 may encounter in deployment—that is, a scenario in which a product item is being held in a hand of a human. The hand may partially obscure the product item from the view of an imaging device, which may make product identification challenging. However, by training computer vision models 138 using images of scenarios that are similar to those that will be encountered in deployment, some aspects of the disclosure may facilitate more efficient computer vision model training and/or more accurate product identification by trained computer vision models.

The server device 134 may be communicatively coupled, via a network 140, with the merchandiser device 102. The network 140 can be or include, for example, the Internet, a local area network (LAN), a wide area network (WAN), a virtual private network (VPN), another public or private means of electronic computer communication capable of transferring data between network-connected devices, or any combination thereof. The network 140 may be a wired network, a wireless network, or a combination thereof. The server device 134 may provide the computer vision component 136 to the merchandiser device 102. The merchandiser device 102 may use the computer vision component 136 to facilitate product identification. The merchandiser device 102 includes a storage assembly 144 with one or more storage areas capable of stowing one or more products. The one or more storage areas may include, for example, one or more rows (e.g., shelves or other horizontal dividers), in which each row includes one or more lanes capable of storing one or more products. In one non-limiting example, the storage assembly 144 may include six rows in which each row has eight lanes, for a total of forty eight lanes in the merchandiser device 102.

The merchandiser device 102 may be a refrigerated unit or a non-refrigerated unit. The merchandiser device 102 may be capable of being locked so as to prevent unauthorized retrieval of a product item from the storage assembly 144. For example, the merchandiser device 102 (or the storage assembly 144 thereof) may be in a locked state when not in use and may temporarily change to an unlocked state to allow a shopper to access to the storage assembly 144 to retrieve a product item. A locked state may be a state, facilitated by any number of different locking mechanisms, in which access to the storage assembly 144 and/or one or more aspects thereof (and/or one or more product items stored therein) may be prohibited. A locking mechanism may include a mechanical device such as a lock on a door of the storage assembly 144, a lock (e.g., a lockable clamp, blocking device, etc.) on a lane of the storage assembly 144, and/or a lock on a product item or set of product items. In some examples, the locking mechanism may be a sensor assembly configured to detect an unauthorized retrieval of a product item and/or an unauthorized ingress of a body part of a shopper into a portion or vicinity of the storage assembly 144. The sensor assembly may be configured to generate an alert status indication responsive to detecting the unauthorized retrieval and/or ingress. The alert status indication may cause the merchandiser device 102 (or another device) to provide an output perceptible to the shopper such as, for example, an audio and/or visual alarm and/or an indication of the alert status. The alert status indication may be provided to a third party such as, for example, a security service and/or a law enforcement service. In some examples, the locking mechanism may provide the alert status indication while also physically preventing retrieval of a product item and, in other cases, the locking mechanism may be configured to provide the alert status indication in lieu of physically preventing retrieval of the product item.

The merchandiser device 102 may in some cases include a door, for example, where the merchandiser device 102 is a refrigerated unit. In one non-limiting example, the storage assembly 144 may store multiple types of canned and/or bottled beverages (e.g., water, soda, and juice), in which each lane includes a single type of canned or bottled beverage. In another non-limiting example, the storage assembly 144 may store single-serving snack packages (e.g., chips, cookies, and crackers), in which each lane includes a single type of single-serving snack package. The merchandiser device 102 may include any number of sensors. The sensors may include an imaging device 146. In particular, an imaging device 146 may include one or more of a laser-based time-of-flight sensor, an ultrasonic-based time-of-flight sensor, a radio detection and ranging (radar) sensor, a light detection and ranging (LiDAR) sensor, an optical proximity sensor, an inductive proximity sensor, a camera, or a video camera. For example, the imaging device 146 may include an imaging device 146 configured to obtain image data associated with a field of view 148. The field of view 148 may be based on any number of different attributes of the imaging device 146 such as, for example, an aperture value, an exposure time, an orientation of the imaging device 146, a focus value of an automatic focusing assembly of the imaging device 146, a lens property, an illumination value, an orientation of an illumination device 150 associated with the imaging device 146, or a sampling parameter, among other examples. In some cases, for example, the imaging device 146 may be configured to obtain image data responsive to detection of a shopper 152 of the self-service retail market system 100 in a vicinity of the merchandiser device 102. In this way, the imaging device 146 may be configured to obtain image data that includes an image of the shopper 152 holding a product item 154.

The merchandiser device 102 includes a computing device 156. The computing device 156 may be configured to facilitate a processing of image data obtained using the imaging device 146. The computing device 156 at least includes a memory, a processor, and a network interface. The memory is configured to store instructions executable by the processor. The processor is configured to execute the instructions stored in the memory. The instructions may include instructions to obtain image data and determine, based on the image data, a product type of a product item detected by the imaging device 146 within the field of view 148. The network interface is configured to communicate output of the processing or other data to one or more other devices, for example, one or more of the server device 134. For example, the computing device 156 may execute, interpret, call, or otherwise run software to use the computer vision component 136 to determine a product type of a product item 154 retrieved by the shopper 152.

To further improve the accuracy of the computer vision component 136, an imaging device 130 associated with the picking station 104 may have an orientation corresponding to an orientation of an imaging device 146 associated with the merchandiser device 102. For example, the imaging device 130 may be positioned in an orientation that results in the field of view 132 being similar to the field of view 148. For example, the imaging device 130 may be positioned so that a lens of the imaging device is aligned with the picking station 104 similarly to an alignment of the imaging device 146 with the storage assembly 144. If the imaging device 146 is disposed above the storage assembly 144, the imaging device 130 may be disposed above the picking station 104. In some examples, image data obtained by the imaging device 146 may be analyzed to determine an orientation of the imaging device 130 that would result in minimization and/or optimization of a difference between the field of view 132 and the field of view 148.

For example, image data obtained via the imaging device 146 may be analyzed to determine one or more most product image profiles associated with the merchandiser device 102. A product image profile may include a set of data associated with a merchandiser device 102 and/or a product type. The set of data of a product image profile may be indicative of a probability distribution corresponding to a region of interest map associated with a product item. For example, image data may be analyzed to determine a map of a product appearance (e.g., a consistently-observed shape, size, and/or color pattern etc.) associated with a product type. The image data may be analyzed to further determine metrics associated with one or more portions (e.g., regions or areas) of the map (e.g., a probability that is indicative of a likelihood that a certain product item is going to be most often observable in image data captured by the imaging device 146). The metrics may be used to determine an orientation of the imaging device 130 so as to result in similar metrics that vary by only a threshold amount. In this way, the orientation of the imaging device 130 may be configured so that an image obtained using the imaging device 130 of a packer 126 holding a product item 124 of a certain product type is most likely to be similar to an image that is likely to be obtained by the imaging device 146 of a shopper 152 holding a product item 154 of that same certain product type. Accordingly, the likelihood of obtaining training data using the imaging device 130 that is similar to image data that will be used as input to a trained computer vision model 138 implemented in association with the merchandiser device 102 may be optimized. In some examples, other imaging parameters (e.g., exposure time, zoom levels, focus levels, a quantity of images to be obtained within a time period, and/or any other imaging parameter) associated with the imaging device 130 may be set so as to result in image data similar to predicted image data obtained using the imaging device 146.

In some examples, one or more attributes of an illumination device 158 associated with the imaging device 130 may be configured to correspond to one or more attributes of an illumination device 150 associated with the imaging device 146. An illumination device 150 or 158 may include, for example, a light, a flash bulb, and/or a combination thereof. An attribute of an illumination device 150 or 158 may include any number of different configurations and/or parameters (e.g., manufacturing parameters and/or operating parameters) associated with the illumination device. For example, the illumination device 158 may be of the same or a similar type as the illumination device 150. The illumination device 158 may be configured to be positioned in an orientation that corresponds to an orientation of the illumination device 150 so that image data obtained by the imaging device 130, in association with an operation of the illumination device 158, may be as similar as possible to image data obtained by the imaging device 146 in association with an operation of the illumination device 150.

In some examples, distance-based product event detection may be used to further facilitate accuracy in product identification associated with self-service retail environments. For example, as explained above, the merchandiser device 102 includes a storage assembly 144 including multiple rows, in which each row includes multiple lanes, and in which each lane is configured to store multiple products. The merchandiser device 102 may include a lane sensor 160 positioned for use with a lane and configured to produce sensor output indicative of an event associated with a product item stored in the lane. An event associated with the product item may be detected based on the sensor output. Identifying information for the product item may be determined based on the sensor output and a planogram of the merchandiser device 102. A quantity of the product item associated with the event may be determined based on the sensor output and dimensional information associated with the product item. Data configured to cause an update to an inventory record associated with the product item may then be output based on the identifying information and the quantity.

The merchandiser lane sensor 160 may represent one or more lane sensors 160. In particular, one or more lanes of one or more of the rows of the merchandiser device 102 may each include one or more lane sensors 160 configured to produce sensor output indicative of an event associated with a product item stored in a subject lane. The lane sensors 160 are mapped to specific lanes of the merchandiser device 102. For example, each lane of each row may have one or more lane sensors 160 thereat. The lane sensors 160 for a subject lane may be permanently integrated within or to a surface of the merchandiser device 102 abutting the subject lane (e.g., a rear interior surface of the lane, a top surface of the lane, or a bottom surface of the lane). Alternatively, the lane sensors 160 for a subject lane may be removably coupled within or to a surface of the merchandiser device 102 abutting the subject lane. Non-limiting examples of a lane sensor 160 may include a laser-based time-of-flight sensor, an ultrasonic-based time-of-flight sensor, a radio detection and ranging (radar) sensor, a light detection and ranging (LiDAR) sensor, an optical proximity sensor, or an inductive proximity sensor.

A lane sensor 160 may, in particular, be used to determine a distance to a product item closest to the lane sensor. For example, where the lane sensor 160 for a given lane of the merchandiser device 102 is a time-of-flight sensor, the lane sensor 160 determines an amount of time it takes for a pulse of light emitted from an optical unit onboard the sensor to be reflected by a surface of a product item closest to the lane sensor 160 and returned to an optical detector onboard the sensor. Sensor output representing a distance between the lane sensor 160 and that closest product item may be determined in one or more ways based on the amount of time determined for the pulse of light to be returned to the light detector. For example, the distance may be determined by dividing that amount of time by two (i.e., halving it) and then multiplying the quotient thereof by the speed of light in air. Time-of-flight sensors and ultrasonic sensors both use cones to conduct their measurements. Time-of-flight sensors may generally have smaller, or narrower, cones than those of ultrasonic sensors. As such, in some cases, time-of-flight sensors may be used as the lane sensors 160 where a size of a subject lane is below or equal a threshold, and ultrasonic sensors may be used as the lane sensors 160 where the size of the subject lane is above that threshold.

In some implementations, one or more of the lane sensors 160 may be permanently coupled or removably coupled to a sensor strip. For example, a sensor strip may include multiple lane sensors 160 within a single lane, such as where the sensor strip is coupled to a top or bottom surface of the lane such that each of the lane sensors 160 of the sensor strip is above or below a different portion of the single lane. In another example, a sensor strip may include one or more lane sensors 160 in each of multiple lanes of a single row, such as where the sensor strip is coupled to a rear interior surface of the merchandiser device 102 such that each of the lane sensors 160 is within a different lane. In yet another example, a sensor strip may include one or more lane sensors 160 in each of multiple lanes of multiple rows, such as where the sensor strip is coupled to a rear interior surface of the merchandiser device 102 such that each of the lane sensors 160 is within a different lane and span at least two rows of the storage assembly 144.

The lanes of the storage assembly 144 may include pushing components. For example, each lane may include a pushing component. Generally, a pushing component is or otherwise refers to a mechanism which causes product items to be moved toward a front of a subject lane when one or more product items are retrieved from that lane. The retrieval of those product items results in an open space filled by the forward motion, caused by the pushing component, of the remaining product items in the lane. A pushing component may be a gravity-based pushing component which uses the natural forces of gravity to push product items forward in a lane, a spring-loaded pushing component which uses a force introduced by a spring connecting the pushing component to an interior of the merchandiser device 102, or another form of pushing component. In some implementations, the lane sensors 160 may be integrated within or otherwise coupled to the pushing components for one or more lanes of the merchandiser device 102.

In some examples, the computing device 156 performs operations for detecting an event associated with a product item stored within a lane of a merchandiser device 102 based on sensor output from a lane sensor 160 (e.g., a time-of-flight sensor) positioned for use with the lane, determining identifying information for the product item based on the sensor output and a planogram of the merchandiser device 102, determining a quantity of the product item associated with the event based on the sensor output and dimensional information associated with the product item, and outputting data configured to cause an update to an inventory record associated with the product item based on the identifying information and the quantity. In some cases, the event refers to one or more product items being retrieved (i.e., removed from) a lane. In some cases, the event refers to one or more product items being replaced (i.e., added to) a lane.

The computing device 156 has access to a mapping associating the lane sensors 160 to the various lanes of the merchandiser device 102, dimensional information indicating sizes of product items within various lanes of the merchandiser device 102, and a planogram indicating a specific layout of specific product items across the various lanes and rows of the merchandiser device 102. The sensor output indicates the lane sensor 160 which produced it, which may be mapped to a specific lane. That lane may be mapped to a specific product item using the planogram to determine the product item associated with the event. The sensor output produced by the lane sensor 160 indicates a distance to a last product item in the lane (i.e., the product item that is farthest from a front of the merchandiser device 102, where a person may stand to retrieve or replace product items). That sensor output can be compared against previous sensor output (e.g., taken at discrete time intervals or on an event basis) to determine a delta representing a distance that changed between the current last product item and the lane sensor 160 and the previous last product item and the lane sensor 160. Based on that distance, a quantity of the product item associated with the event can be determined. The computing device 156 then outputs data indicative of the determined product and quantity, such as to update inventory records (e.g., by decreasing the inventory records associated with the subject product by the determined quantity thereof where the event is a product retrieval or by increasing the inventory records associated with the subject product by the determined quantity thereof where the event is a product replacement).

The planogram for the merchandiser device 102, which is used to determine a product item associated with an event, maps information about specific products to specific lanes within the merchandiser device 102 in which those products are stocked. In some cases, the planogram or information associated therewith may be stored within a memory of the computing device 156. For example, the computing device 156 can access a local data store storing the planogram or information associated therewith based on a detection of an event associated with a lane of the merchandiser device 102. In particular, the computing device 156 can use the sensor output produced by a lane sensor 160 to determine which lane the event corresponds to and can then determine the product item associated with the event based on information of the planogram specifying a certain product item within that lane. Non-limiting examples of the planogram may include an illustrative mapping, a comma separated value file, a two-dimensional matrix or array of values, or a list.

The dimensional information associated with the various products of the planogram identifies size information for the product items in one or more dimensions. In some cases, the dimensional information may identify height, width, and depth information for a product item. In some cases, the dimensional information may be limited to depth information for the product item, as the depth information relates to a distance occupied by the product item between the front and back of a given lane. The dimensional information may, for example, be input to the system 100 from a data source. The computing device 156 can access a local data store storing the dimensional information based on a detection of an event associated with a lane of the merchandiser device 102. For example, the dimensional information may be stored in connection with the planogram (or the information associated therewith, as applicable) or in a separate data store. The computing device 156 can use the dimensional information to determine a quantity of the product item that is associated with the event (e.g., a number of the product item that is either retrieved or replaced as the event).

The computing device 156 may be configured to continuously monitor for events associated with lanes of the merchandiser device 102 and/or to monitor for events based on a trigger. For example, where continuous monitoring is performed, the lane sensors 160 produce sensor output on a continuous and periodic basis, such as ten times per second, to monitor for events. In another example, where a trigger is used, the computing device 156 may be placed in a wait state while awaiting the trigger and change to an active state during which the lane sensors 160 produce sensor output to monitor for events based on the trigger. Non-limiting examples of a trigger which can cause the computing device 156 to begin monitoring for events include a door of the merchandiser device 102 being opened (in implementations in which the merchandiser device 102 includes a door) or one or more images captured by the imaging device 146 associated with the merchandiser device 102 depicting a potential interaction with the merchandiser device 102. For example, the merchandiser device 102 may include one or more imaging devices 146 associated with the storage assembly 144 that monitor for event-related activity, such as a person reaching into the merchandiser device 102 and grabbing one or more products within a lane thereof putting one or more products back into a lane thereof, and/or activity related to other interactions with the merchandiser device 102, such as a person opening a door thereof. In such a case, images captured by those one or more imaging devices 146 within the storage assembly 144 may be used to determine the trigger. In another example, one or more imaging device 146 may be located external to the merchandiser device 102 and to capture images depicting an area around and including the merchandiser device 102. The external one or more imaging devices 146 may monitor for event-related activity or other interactions with the merchandiser device 102, as described above with respect to imaging devices 146 of the storage assembly 144. In such a case, images captured by those one or more imaging devices 146 external to the merchandiser device 102 may be used to determine the trigger. In yet another example, where the merchandiser device 102 includes a door, the merchandiser device 102 may include a door sensor (e.g., a magnetic sensor configured to determine whether the door of the merchandiser device 102 is opened or closed). In such a case, sensor output produced by that door sensor may be used to determine the trigger.

In some implementations, the computing device 156, via the lane sensors 160 and/or other components such as the imaging devices 146 associated with the storage assembly 144 and/or imaging devices 146 external to the merchandiser device 102, may be configured to detect events other than those corresponding to product retrievals or product replacements associated with lanes of the merchandiser device 102. For example, the computing device 156 may be configured to detect wrong lane events corresponding to the replacement of one or more product items within a lane other than the lane from which they were retrieved. In another example, the computing device 156 may be configured to detect suspicious activity associated with the merchandiser device 102, such as the consumption of a consumable product item retrieved from the merchandiser device 102 and the subsequent replacement of the consumed product package within the merchandiser device 102.

In some implementations, the computing device 156 may be configured to simultaneously detect multiple events each associated with a different lane of the merchandiser device 102. For example, a consumer, using both of their hands, may in some cases simultaneously retrieve one or more products from each of two lanes. In such a case, the product retrievals from each lane would correspond to their own events. The detection and processing of each such event may be simultaneously performed by the computing device 156. Alternatively, in some implementations, the sensor output produced by the lane sensors 160 of the subject lanes may be added to a data structure, such as a queue, for sequential processing based on an order in which the sensor output is received by the computing device 156.

The system 100 includes multiple devices which may connect to the merchandiser device 102 via the computing device 156, such as the server device 134, an operator device 162, a management device 164, and a consumer device 166. The computing device 156 communicates with the one or more of the server device 134, the operator device 162, the management device 164, or the consumer device 166 over the network 140. The server device 134 may provide information usable by the computing device 156 to perform some or all of the functionality for monitoring inventory states of products stored in the lanes of the merchandiser device 102 based on events detected according to sensor output produced by the lane sensors 160 and/or the imaging device(s) 146. For example, the server device 134 may provide to the computing device 156 information associated with products stored within the storage assembly 144, such as dimensional information thereof. In another example, the server device 134 may provide update data usable to cause the computing device 156 to update some or all of the software executed, interpreted, called, or otherwise run thereat. The server device 134 may be located on premises at the store or other location of the merchandiser device 102. Alternatively, the server device 134 may be remote from such location, for example, in a datacenter.

The operator device 162 may be a computing device used by a person who operates the merchandiser device 102. For example, the operator device 162 may be a mobile device of a person who works at a store or other location at which the merchandiser device 102 is located, such as a person tasked with monitoring product inventories and maintaining stock of product items in the merchandiser device 102. The operator device 162 may receive alerts in connection with one or more events detected by the computing device 102. For example, the operator device 162 may receive an alert when a stock of a given product item within a merchandiser device 102 falls below a threshold. In another example, the operator device 162 may receive an alert when wrong lane events related to the replacement of a product item in an incorrect lane are detected by the computing device 156. In yet another example, the operator device 162 may receive an alert when suspicious activity is detected in connection with the merchandiser device 102.

The management device 164 may be a computing device used by a person who manages the merchandiser device 102 or otherwise who manages a store or other location at which the merchandiser device 102 is operated. For example, the management device 164 may be a desktop or laptop computer within an office at a retail store that includes the merchandiser device 102. The management device 164 may be used to create, assert, and/or update a planogram for the products of the merchandiser device 102. The management device 164 may receive inventory alerts related to trends in product transactions and be used to implement product stock changes based on analyses over those trends. The management device 164 may receive information related to individual events detected at the merchandiser device 102, product items associated with events, transactions processed in connection with those product items, and the like.

The consumer device 166 may be a computing device used by a consumer who causes an event at the merchandiser device 102. For example, the consumer device 166 may be a smartphone running a mobile application or a web application (e.g., via a web browser) at which information associated with a user account registered for purchasing product items from the merchandiser device 102 can be viewed. The consumer device 166 may receive alerts related to products retrieved by the consumer from the merchandiser device 102, products replaced by the consumer within the merchandiser device 102, and transactions processed in connection with product items retrieved by the consumer from the merchandiser device 102. In some cases, the mobile application or web application at the consumer device 166 may be used to facilitate or otherwise complete a transaction for a product item retrieved from the merchandiser device 102, for example, based on information associated with the product item communicated from the computing device 156 or identified by a scanning of the product item (e.g., a barcode thereof) at a camera of the consumer device 166, or the like. The consumer device 166 may display information associated with an account of the consumer before and/or after such a transaction is processed.

There may be multiple ones of the merchandiser device 102 in a retail store or other retail area. For example, a self-service convenience store area in an office building may include a first merchandiser device that stores refrigerated products and a second merchandiser device that stores non-refrigerated products. In another example, a retail store (e.g., a self-service retail store) may include tens of merchandiser devices arranged throughout the store. Generally, where there are multiple ones of the merchandiser device 102 in a given store or area, each of the merchandiser devices 102 may include its own separate computing device 156. However, in some implementations in which there are multiple ones of the merchandiser device 102 in a given store or area, the computing device 156 may be shared between the multiple merchandiser devices rather than each merchandiser device including its own separate computing device 156. For example, a single computing device 156 may be configured to process sensor output produced at each of multiple merchandiser devices according to information specific to the subject merchandiser device and to communicate the processed data, individually or in a batch, to one or more devices, as disclosed above.

Regardless of a number of the merchandiser device 102 in a given store or area, in some implementations, the computing device 156 may be an integrated circuit, (e.g., an application-specific integrated circuit (ASIC)), a field-programmable gate array (FPGA), a system-on-a-chip (SoC), or another special purpose device. For example, the computing device 156, as an ASIC, FPGA, or SoC, may be configured to perform some or all the functionality of the product event processing software disclosed herein. In some such implementations, the computing device 156 may be configured to obtain image data from the imaging device 146 and/or sensor output from the lane sensor 160 and transmit the image data and/or sensor output to a device over the network 140, such as the server device 134, the operator device 162, or the management device 164. For example, the server device 134, the operator device 162, or the management device 164 may in such a case be configured to perform other (e.g., some or the remaining) functionality of the product event processing software disclosed herein. Thus, while product event processing may in some implementations be performed entirely locally at the merchandiser device 102, in other implementations it may be at least partially performed remotely from the merchandiser device 102.

In some implementations, one or more of the server device 134, the operator device 162, the management device 164, and the consumer device 166 may be combined into a single device. For example, a single device may be used as both the operator device 162 and the management device 164.

In some implementations, the merchandiser device 102 may include multiple computing devices 156. For example, where the lane sensors 160 are included in sensor strips, each sensor strip may include its own computing device 156, or multiple sensor strips may share a single computing device 156. Similarly, each imaging device 146 may include its own computing device 156, or multiple imaging devices 146 may share a single computing device 156. In some implementations, individual lane sensors 160 (or sensor strips) and/or imaging device 146 may be movable in association with the storage assembly 144. For example, the rows and/or lanes may be of adjustable sizes to accommodate various types of product items and planograms of product items. An operator of the merchandiser device 142 may thus configure the rows and/or lanes, and thus the lane sensors 160 and/or imaging devices 146 individually or as sensor strips, as needed. In one non-limiting example, a first row of the merchandiser device 102 may have a height of ten inches measured from a bottom surface of the row to a top surface of the row and include eight lanes, while a second row of the merchandiser device 102 may have a height of two feet measured from the bottom surface to the top surface thereof and include four lanes.

In some implementations, product management software 168 may be hosted by the server device 134 and may be configured to facilitate using computer vision for product identification. The product management software 168 can be distributed across more than one device (e.g., more than one server device 134). In some implementations, the product management software 168 may be hosted on a different device in addition to, or in lieu of, a server device 134. For example, in some implementations, the product management software 168 may be hosted by the picking station 104, the merchandiser device 102, the operator device 162, the management device 164, and/or the consumer device 166, among other examples. The product management software 168 may be, include, or be included in, an apparatus for using computer vision for product identification in association with a self-service retail market environment.

In some implementations, the product management software 168 may be included in a processing system that includes an apparatus having one or more memories (on which the product management software 168 is stored) and one or more processors coupled with the one or more memories. The one or more processors may be configured to execute the product management software 168 to cause the apparatus to perform one or more operations. The one or more operations may include, for example, obtaining an inventory order. An inventory order may be a set of information indicative of one or more product items to be provided to a merchandiser device 102 associated with a self-service retail market. For example, an operator (e.g., an owner, manager, employee of a company that manages operations of the merchandiser device 102, etc.) of the merchandiser device 102 may provide user input to the operator device 162 (and/or the management device 164) to cause the operator device 162 (and/or the management device 164) to generate an inventory order and/or to transmit the inventory order to the server device 134. In some implementations, the operator device 162 (and/or the management device 164) may generate and/or transmit the inventory order automatically such as, for example, in response to a detection, by the operator device 162 (and/or the management device 164) of an occurrence of an order trigger event. The operator device 162 (and/or the management device 164) may detect the occurrence of the order trigger event by obtaining information indicative of an inventory quantity of a product item dropping below a threshold. In some implementations, the order trigger event may correspond to a calendar date, a day of the week, and/or another metric configured to facilitate a periodic or semi-periodic ordering schedule.

The one or more processors may be configured to execute the product management software 168 to cause the apparatus to initiate a bin-packing operation for fulfilling the inventory order. For example, the product management software 168 may cause the apparatus to initiate the bin-packing operation by providing information associated with a bin-packing operation to the picking controller 118. The one or more processors may be configured to cause the apparatus to obtain, via the imaging device 130 associated with the picking station 104 for inventory order fulfillment, first image data corresponding to a first product item 124 having a product type. The one or more processors may be configured to cause the apparatus to determine, in association with the picking station 104, the product type. For example, the one or more processors may be configured to cause the apparatus to determine the product type by receiving, from a computing device (e.g., a picking controller 118) associated with the picking station 104, labeling data indicative of a product type identifier corresponding to the product type. The product type identifier may include, for example, a stock keeping unit (SKU), an inventory number, a serial number and/or any other identifier that may be associated with a product type. A product type may refer to a specific product, a specific group of products, a specific class, a specific brand, a specific product line, and/or a specific category of products, among other examples. The labeling data may include a storage component identifier corresponding to a storage component 106 of the picking station 104 from which the first product item 124 is removed, and the one or more processors may be configured to cause the apparatus to determine the product type identifier using a database that includes a stored indication of an association between the storage component identifier and the product type identifier. In some examples, the labeling data may indicate the product type identifier.

The one or more processors may be configured to cause the apparatus to associate the product type identifier with the first image data. For example, the one or more processors may be configured to cause the apparatus to train the computer vision model 138 by providing the first image data as input to one or more neural networks and to provide the labeling data to the one or more neural networks to be used for labeling and/or determining error associated with output from the one or more neural networks. Using the labeling data, the one or more processors may be configured to cause the apparatus to train the computer vision model 138 to be configured to be used to determine a product type based on image data.

The one or more processors may be configured to cause the apparatus to generate the computer vision component 136 associated with at least the product type (e.g., based on the computer vision model 138). The one or more processors may be configured to cause the apparatus to provide the computer vision component 136 for use with the merchandiser device 102. For example, the server device 134 may transmit the computer vision component 136 to the merchandiser device 102.

The one or more processors may be further configured to cause the apparatus to generate, based at least in part on the computer vision model 138, a planogram associated with the merchandiser device 102. In some cases, the one or more processors may cause the apparatus to generate the planogram associated with the merchandiser device 102 based on the first image data and/or any other type of information that may be provided to the product management software 168. The server device 134 may transmit the planogram to the merchandiser device 102.

In some implementations, merchandiser device 102, which also may include a processing system including one or more memories and one or more processors coupled with the one or more memories. The one or more processors of the merchandiser device 102 may be configured to cause the merchandiser device 102 to obtain, via the merchandiser imaging device 130, second image data associated with a second product item 154. The one or more processors of the merchandiser device 102 may be configured to cause the merchandiser device 102 to determine, using the computer vision component 136 and based at least in part on the second image data, a product type of the second product item 154. The one or more processors of the merchandiser device 102 may be configured to cause the merchandiser device 102 to facilitate a product transaction operation based on determining that the product type.

FIG. 2 is a block diagram of an example of an internal configuration of a computing device 200 of a self-service retail market system, such as the system 100 depicted in FIG. 1, in accordance with the present disclosure. In some implementations, the computing device 200 may be, be similar to, include, or be included in, an apparatus configured to perform one or more aspects of one or more processes described herein. For example, the computing device 200 may be, be similar to, include, or be included in, the picking controller 118, the server device 134, the imaging device 130, the imaging device 146, the computing device 156, the operator device 162, and/or the management device 164 shown in FIG. 1. The computing device 200 includes components such as a processor 202, a memory 204, a bus 206, a power source 208, a peripheral component 210, an input/output component 212, and a network component 214. One of more of the memory 204, the power source 208, the peripheral component 210, the input/output component 212, or the network component 214 can communicate with the processor 202 via the bus 206. The processor 202, the memory 204, and the bus 206 may be referred to as a processing system. Accordingly, a statement that indicates that the processor 202 (or one or more processors) performs an action may be equivalent to a statement that the processing system performs an action, and vice-versa.

The processor 202 is a central processing unit, such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in any manner, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory of the memory 204 can be random access memory (RAM) (e.g., a DRAM module, such as DDR SDRAM) or another form of volatile memory. In another example, the non-volatile memory of the memory 204 can be a disk drive, a solid-state drive, flash memory, phase-change memory, or another form of non-volatile memory configured for persistent electronic information storage. The memory 204 may also include other types of devices, now existing or hereafter developed, configured for storing data or instructions for processing by the processor 202.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. The operating system 220 can be, for example, Microsoft Windows®, Mac OS X®, or Linux®; an operating system for a small device, such as a smartphone or tablet device; or an operating system for a large device, such as a mainframe computer. In some implementations, although illustrated as separate components, the application data 218 and the operating system 220 may be included in and/or be instantiated based at least in part on execution of one or more executable instructions of the executable instructions 216.

The power source 208 includes a source for providing power to the computing device 200. For example, the power source 208 can be an interface to an external power distribution system. In another example, the power source 208 can be a battery, such as where the computing device 200 is a mobile device or is otherwise configured to operate independently of an external power distribution system.

The peripheral component 210 includes one or more peripherals (e.g., devices external to the computing device 200 (referred sometimes as “external devices”) and/or one or more peripheral interfaces used to interface the one or more peripherals with the computing device 200 and/or one or more components thereof. The one or more peripherals may include sensors, detectors, or other devices configured for monitoring the computing device 200 and/or the environment around the computing device 200. For example, the peripherals may include a geolocation component, such as a global positioning system location unit. In an example, the peripherals may include a temperature sensor for measuring temperatures of components of the computing device 200, such as the processor 202. In an example, the peripherals may include an imaging device for obtaining optical information of the computing device 200 and/or the environment around the computing device 200. In some examples, peripherals may include a barcode scanner, a funds dispenser, a biometric sensor, and/or a card reader, among other examples. Peripheral interfaces may include software (e.g., drivers and/or virtual ports) used to interface hardware components of the computing device 200 with external devices. Peripheral interfaces may also or instead include hardware (e.g., physical ports and/or related circuitry) used to interface with the external devices.

The input/output component 212 includes one or more input interfaces and/or output interfaces. An input interface may include an input device configured to receive input from a user (e.g., via an interaction between the user and the input device) and/or a machine (e.g., via an interaction between the machine and the input device). An input device may include a mouse, a touchscreen, a keyboard, a microphone, an imaging device, a touchpad, and/or another suitable human or machine interface, among other examples. An output interface may include an output device configured to obtain output information from the processing system and provide a representation (e.g., a visual, audio, and/or tactile representation) of the output information. An output device may, for example, be a display, a light, a speaker, and/or a tactile output device, among other examples.

The network component 214 provides a connection or link to a network such as, for example, an LAN, a WAN, a machine-to-machine network, a VPN, and/or another public or private network. The network component 214 may include a wired network interface and/or a wireless network interface. The computing device 200 can communicate with other devices via the network component 214 using one or more network protocols such as, for example, Ethernet, transmission control protocol (TCP), internet protocol (IP), power line communication, Wi-Fi, Bluetooth®, infrared, general packet radio service (GPRS), global system for mobile communications (GSM), code division multiple access (CDMA), Z-Wave, ZigBee, long term evolution (LTE), and/or New Radio (NR), among other examples.

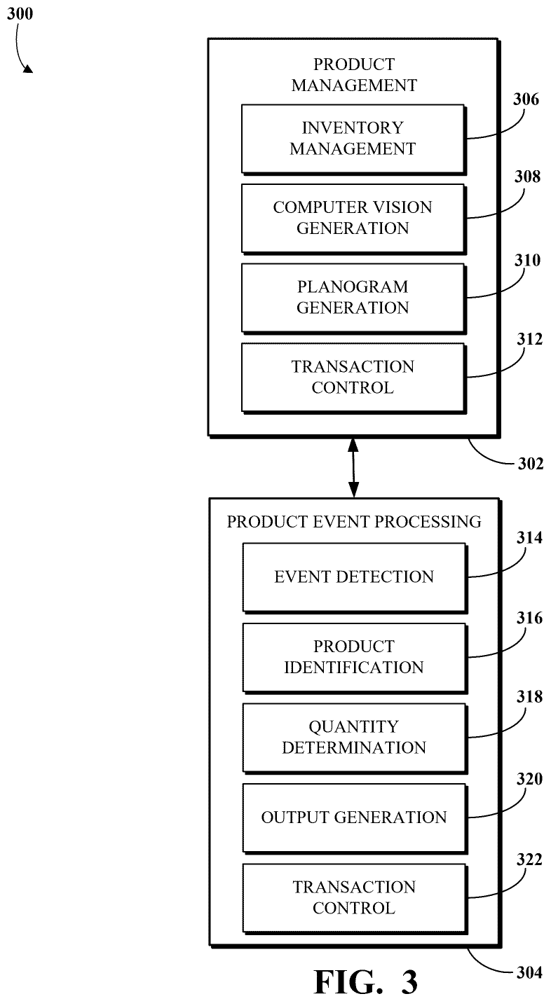

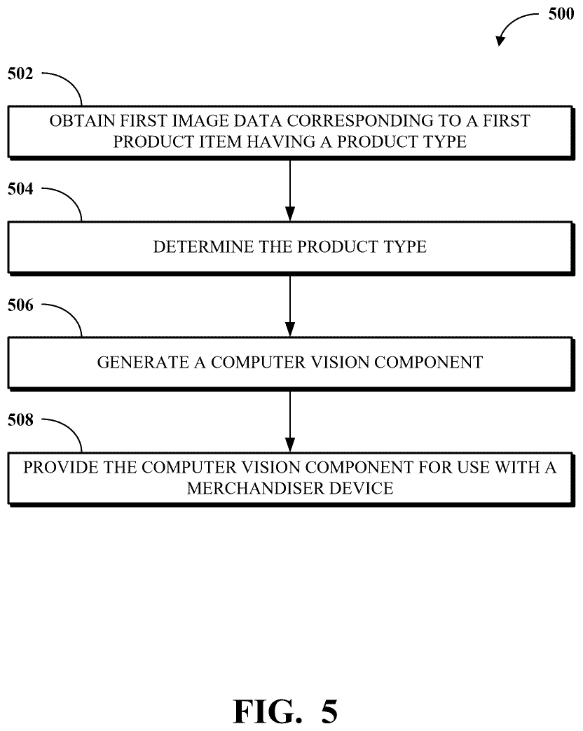

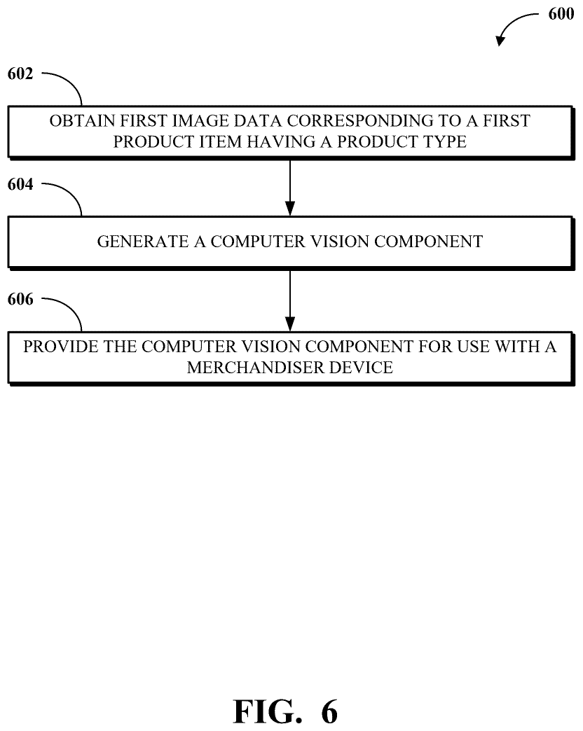

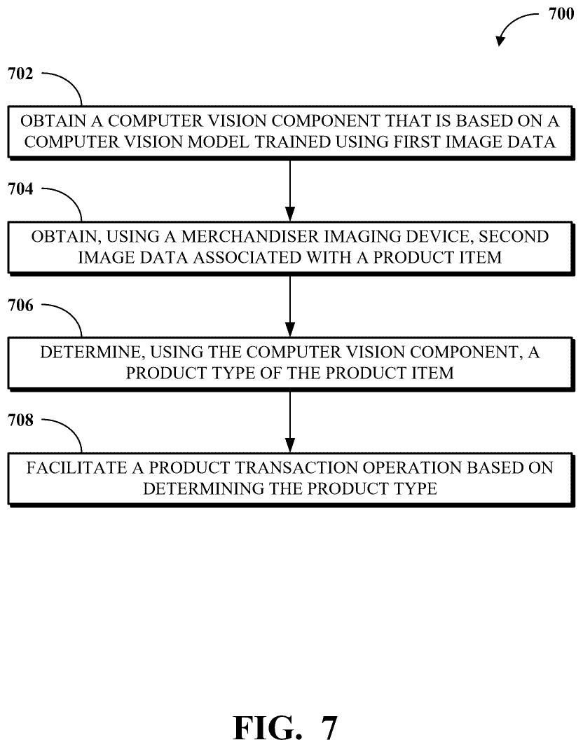

The processor 202 and/or any other component(s) of FIG. 2 may perform one or more techniques associated with using computer vision for product identification in association with a self-service retail market, as described in more detail elsewhere herein. For example, the processor 202 and/or any other component(s) of FIG. 2 may perform or direct operations of, for example, the technique 500 of FIG. 5, the technique 600 of FIG. 6, the technique 700 of FIG. 7, and/or other techniques as described herein. The memory 204 may store data and program codes for the computing device 200. In some examples, the memory 204 may include a non-transitory computer-readable medium storing one or more instructions (e.g., code and/or program code) for wireless communication. For example, the one or more instructions, when executed (e.g., directly, or after compiling, converting, and/or interpreting) by one or more processors 202 of the computing device 200, may cause the one or more processors 202, the computing device 200, and/or an apparatus associated with the computing device 200 to perform or direct operations of, for example, the technique 500 of FIG. 5, the technique 600 of FIG. 6, the technique 700 of FIG. 7, and/or other techniques as described herein. In some examples, executing instructions may include running the instructions, converting the instructions, compiling the instructions, and/or interpreting the instructions, among other examples. For example, the executable instructions 216 may include a set 222 of instructions that include, for example, the product management software 166, the product management software 302 depicted in FIG. 3, and/or the product event processing software 304 depicted in FIG. 3.

In some implementations, the computing device 200 includes means for obtain, via an imaging device associated with a picking station for inventory order fulfillment, first image data corresponding to a first product item having a product type; means for determining, in association with the picking station, the product type; means for generating, using at least the first image data, a computer vision component associated with at least the product type, wherein the processing system, to generate the computer vision component, is configured to cause the apparatus to train a computer vision model using at least the first image data and a product type identifier corresponding to the product type; and means for providing the computer vision component for use with a merchandiser device, wherein the computer vision component is configured to facilitate, based on second image data, identification of a second product item having the product type.

In some implementations, the computing device 200 includes means for obtaining, via an imaging device associated with a picking station for inventory order fulfillment, first image data corresponding to a first product item having a product type; means for generating, using at least the first image data, a computer vision component associated with at least the product type, wherein generating the computer vision component comprises training a computer vision model using at least the first image data and a product type identifier corresponding to the product type; and means for providing the computer vision component for use with a merchandiser device, wherein the computer vision component is configured to facilitate, based on second image data, identification of a second product item having the product type.

In some implementations, the computing device 200 includes means for obtaining, via a product event manager, a computer vision component, wherein the computer vision component is based on a computer vision model trained using first image data associated with a bin-packing operation in which a first product item, having a product type, is removed from a picking station and placed in a stocking bin associated with the self-service retail market environment, the first image data corresponding to one or more images of a packer holding the first product item; means for obtaining, via a merchandiser imaging device comprising at least one merchandiser camera, second image data associated with a second product item; means for determining, using the computer vision component and based at least in part on the second image data, that the second product item has the product type; and means for facilitating a product transaction operation based on determining that the second product item has the product type.

The means for the computing device 200 to perform operations described herein may include, for example, one or more of the executable instructions 216, processor 202, memory 204, power source 208, peripheral component 210, input/output component 212, and/or network component 214, among other examples.

Any one or more of the components depicted in FIG. 2 may represent one or more of that respective component. For example, the processor 202 may be one or more processors 202, the memory 204 may be one or more memories 204, the power source 208 may be one or more power sources 208, the peripheral component 210 may be one or more peripheral components 210, the input/output component 212 may be one or more input/output components 212, and the network component 214 may be one or more network components 214.

In some implementations, the processor 202, memory 204, and the bus 206 may represent a processing system. A processing system may include one or more processors 202 and one or more memories 204 distributed within one or more computing devices (e.g., via a plurality of servers in one or more locations, each server including one or more processors 202 and one or more memories 204 used to implement some or all of the techniques of this disclosure). A processor operation may be an operation described herein as being performed by a processor and/or an operation described herein as being caused, by a processor, to be performed (e.g., an operation that a processor causes an apparatus to perform). In some implementations, a single processor of the one or more processors 202 may perform all of the processor operations described herein as being performed by, or being caused to be performed by, a processor. In some implementations, multiple processors of the one or more processors 202 may perform all of the processor operations described herein as being performed by, or being caused to be performed by, a processor. In some implementations, each processor of multiple processors of the one or more processors 202 may perform a same or different processor operation as another processor of the one or more processors 202. In some implementations, for example, a first set of (one or more) processors of the one or more processors 202 may perform a first processor operation described herein as being performed by, or being caused to be performed by, a processor; and a second set of (one or more) processors of the one or more processors 202 may perform a second operation described herein as being performed by, or being caused to be performed by, a processor. The first set of processors and the second set of processors may be the same set of processors or may be different sets of processors. Reference to “a memory” should be understood to refer to any one or more memories of a corresponding device, such as the one or more memories 204 described in connection with FIG. 2. For example, instructions described as being stored in a memory can be stored in the same subset of the one or more memories 204 or different subsets of the one or more memories 204.

Implementations of the computing device 200 may differ from what is shown and described above with respect to FIG. 2. In some implementations, the computing device 200 can omit the peripherals 210. In some implementations, the memory 204 can be distributed across multiple devices. For example, the memory 204 can include network-based memory or memory in multiple clients or servers performing the operations of those multiple devices. In some implementations, the application data 218 can include functional programs, such as a web browser, a web server, a database server, another program, or a combination thereof.

FIG. 3 is a block diagram illustrating an example of a self-service retail market system 300 in accordance with the present disclosure. The self-service retail market system 300 includes product management software 302 and product event processing software 304.

The product management software 302 includes components, such as programs, subprograms, functions, routines, subroutines, operations, and/or the like for managing (e.g., maintaining, tracking, updating, etc.) inventory states of products delivered to a warehouse, stored in the warehouse, shipped from the warehouse to a self-service retail market environment, and/or purchased from the self-service retail market environment by a consumer. The product management software 302 may be implemented (e.g., stored, instantiated, executed, interpreted, called, or otherwise run) at one or more computing devices such as, for example, the computing device 200. For example, the product management software 302 may be implemented at the picking controller 118, the server device 134, the computing device 156, the operator device 162, and/or the management device 164 shown in FIG. 1. The product management software 302 may be configured to communicate with the product event processing software 304.

The product event processing software 304 includes components, such as programs, subprograms, functions, routines, subroutines, operations, and/or the like for managing (e.g., maintaining, tracking, updating, etc.) inventory states of delivered to a self-service retail market environment, stored in the self-service retail market environment, and/or purchased from the self-service retail market environment by a consumer. The product event processing software 304 may be implemented (e.g., stored, instantiated, executed, interpreted, called, or otherwise run) at one or more computing devices such as, for example, the computing device 200. For example, the product management software 302 may be implemented at the server device 134, the computing device 156, the operator device 162, and/or the management device 164 shown in FIG. 1. The product event processing software 304 may be configured to communicate with the product management software 302.

As shown, the product management software 302 includes an inventory management component 306, a computer vision generation component 308, a planogram generation component 310, and a transaction control component 312. Any two or more of the components 306, 308, 310, and 312 may be integrated with one another. Any one or more of the components 306, 308, 310, and 312 may be distributed across any number of different computing devices. For example, in some implementations, all of the components 306, 308, 310, and 312 may be hosted on a single computing device or a single system of devices that may be maintained by a single entity. Any one or more of the components 306, 308, 310, and 312 may be configured to perform any aspect, or combination of aspects, of one or more techniques and/or operations described herein. Thus, a statement herein that indicates that one or more components of the components 306, 308, 310, and 312 performs an action (and/or has a characteristic) may be equivalent to a statement that the product management software 302 performs the action (and/or has the characteristic). Similarly, a statement that the product management software 302 performs an action (and/or has a characteristic) may be equivalent to a statement that one or more of the components 306, 308, 310, and 312 performs the action (and/or has the characteristic).

The inventory management component 306 (which may be, include, or be included in an inventory management system that may include any number of devices and/or other software components) manages inventory associated with a self-service retail market system. The inventory management component 306 may be configured to facilitate tracking of inventory as it moves between a warehouse to a self-service retail market environment and from the self-service retail market environment to a customer. The inventory management component 306 may include any number of different types of databases and may be configured to interface with any number of different systems and/or components of systems. When a product item is delivered by a distributer to a warehouse, for example, information may be provided to the inventory management component 306 indicative of receipt, at the warehouse, of the product item. The information may include a product type identifier such as, for example, a SKU, a serial number, and/or a product number. The information may be indicative of one or more characteristics of the product item.

When the product item is placed in a storage compartment at the warehouse (e.g., a storage compartment 114 shown in FIG. 1), a storage indication may be provided (e.g., by a corresponding picking controller such as, e.g., the picking controller 118 shown in FIG. 1) to the inventory management component 306. The storage indication may be indicative of a storage component identifier corresponding to the storage component. The inventory management component 306 may store, in a database, an indication of an association between the product type identifier and the storage compartment identifier. In this way, the inventory management component 306 may track associations between storage compartments and product types of the products stored therein. The inventory management component 306 may be configured to track and maintain associations between any number of different storage compartments and product types. The inventory management component 306 also may maintain information indicative of a quantity of product items of a product type that are stored in a storage compartment. The inventory management component 306 may maintain information indicative of an association between a storage compartment and a picking station. In this way, the inventory management component 306 may maintain and track inventory across many different picking stations, each of which may have any number of storage compartments.

When a packer removes a product item from a storage compartment, the corresponding picking controller may provide, to the inventory management component 306, an indication to the inventory management component 306. The indication may include a storage compartment identifier, a picking station identifier, and/or a product type identifier. In some examples, the picking controller also may provide, to the inventory management component 306, image data received from an imaging device associated with the picking station. Based on receiving the indication, the inventory management component 306 may update data in a database to reflect that the storage compartment includes one less product item of the indicated product type.

The inventory management component 306 may be configured to perform any number of tasks associated with a bin-packing operation. The inventory management component 306 may be configured to track inventory within a warehouse, provide packing instructions to a packer, interface with a picking station 104 (and/or one or more components thereof) to facilitate exchange of information that may be used to facilitate a bin-packing operation. For example, the inventory management component 306 may obtain a packing order (e.g., via an operator device and/or a merchandiser device) that indicates one or more product types and one or more quantities associated with the respective product types. The inventory management component 306 may generate (autonomously and/or responsive to operator input) a packing plan. A packing plan may be a data structure indicative of packing instructions for packing a stocking bin. For example, the inventory management component 306 may provide the packing plan to a picking station (e.g., by transmitting one or more signals to one or more picking controllers such as, for example, the picking controller 118 shown in FIG. 1). The packing plan may indicate, for a merchandiser device that is to be stocked (e.g., the merchandiser device 102 shown in FIG. 1), a set of product types and corresponding quantities. In some cases, picking controller may display a representation of one or more aspects of the packing plan to a packer. In some examples, the inventory management component 306 may provide the packing plan to an operator device (e.g., the operator device 162 shown in FIG. 1). A packer may pack a stocking bin in accordance with the packing plan. The inventory management component 306 may receive an inventory indication corresponding to the first product item. For example, the inventory indication may indicate the addition of the first product item to the stocking bin and/or a removal of the first product item from the picking station.

The computer vision generation component 308 may be configured to obtain, via an imaging device associated with a picking station for inventory order fulfillment, first image data corresponding to a first product item having a product type. The computer vision generation component 308 may be configured to determine, in association with the picking station, the product type. As described above in connection with FIG. 1, the first image data may be associated with a bin-packing operation in which the first product item is removed from a storage component of the picking station and placed in a stocking bin associated with a self-service retail market environment. The first image data may correspond to one or more images of a packer holding the first product item.

The computer vision generation component 308 may be configured to receive, from the inventory management component 306, labeling data indicative of the product type identifier. The computer vision generation component 308 may be configured to generate a computer vision component by training one or more computer vision models using the labeling data. The combination of the labeling data and the first image data may be referred to as training data. For example, the computer vision generation component 308 may associate the product type identifier with the first image data. In some examples, the labeling data may include a storage component identifier corresponding a storage component of the picking station from which the first product item is removed. The computer vision generation component 308 may determine a product type identifier associated with the first product item by determining the product type identifier using a database comprising a stored indication of an association between the storage component identifier and the product type identifier. In some examples, the computer vision generation component 308 may obtain a storage component identifier corresponding to the storage component and may access database that includes a stored indication of an association between the storage component identifier and the product type identifier. In some examples, the labeling data may include the product type identifier.

The computer vision generation component 308 may train one or more computer vision models using additional image data. For example, the computer vision generation component 308 may obtain, via an imaging device, third image data corresponding to a third product item having an additional product type and may train the one or more computer vision models based at least in part on the third image data. The computer vision generation component 308 may generate, using at least the first image data, a computer vision component associated with at least the product type. For example, the computer vision generation component 308 may generate the computer vision component based on the one or more trained computer vision models. The product management software 302 may provide the computer vision component to the product event processing software 304.

The planogram generation component 310 may be configured to generate, based at least in part on the computer vision model, a planogram associated with a merchandiser device. For example, the planogram generation component 310 may take, as input, the first image data and/or the computer vision component and may provide, as output, a planogram based thereon. In some examples, the planogram generation component 310 generate the planogram based on any number of other types of information such as, for example, market data (e.g., data associated with purchasing trends, consumer behaviors, etc.), environmental data (e.g., data associated with weather events, temperatures, seasons, etc.), societal data (e.g., data associated with societal changes, movements, characteristics, etc.), consumer demographic data (e.g., data associated with consumers), and/or economic data (e.g., data associated with macro-economic systems, micro-economic systems, etc.), among other examples. In this way, for example, the planogram generation component 310 may generate planograms that are designed to facilitate product placement that corresponds to an improved likelihood of resulting in sales.

The transaction control component 312 may be configured to facilitate transactions associated with product items. For example, the transaction control component 312 may interact with a merchandiser device and/or a consumer device to facilitate a transaction for the purchase, by a consumer, of one or more product items from a self-service retail market environment. In some examples, the transaction control component 312 may cause a graphical user interface (GUI) to be presented on a display device of a merchandiser device and/or a consumer device. A consumer may interact with the GUI to provide payment information, thereby facilitating a transaction. In some examples, the transaction control component 312 may interact with the transaction control component 322 of the product event processing software 304 to facilitate a transaction. Based on a completion of a transaction, the transaction control component 312 may provide information indicating the completion of the transaction to the inventory management component 306, which may update inventory information accordingly.

As shown, the product event processing software 304 includes an event detection component 314, a product identification component 316, a quantity determination component 318, an output generation component 320, and a transaction control component 322. Any two or more of the components 314, 316, 318, 320, and 322 may be integrated with one another. Any one or more of the components 314, 316, 318, 320, and 322 may be distributed across any number of different computing devices. For example, in some implementations, all of the components 314, 316, 318, 320, and 322 may be hosted on a single computing device or a single system of devices that may be maintained by a single entity. Any one or more of the components 314, 316, 318, 320, and 322 may be configured to perform any aspect, or combination of aspects, of one or more techniques and/or operations described herein. Thus, a statement herein that indicates that one or more components of the components 314, 316, 318, 320, and 322 performs an action (and/or has a characteristic) may be equivalent to a statement that the product event processing software 304 performs the action (and/or has the characteristic). Similarly, a statement that the product event processing software 304 performs an action (and/or has a characteristic) may be equivalent to a statement that one or more of the components 314, 316, 318, 320, and 322 performs the action (and/or has the characteristic). The transaction control component 312 may be, be similar to, include, or be included in, the transaction control component 322.

The event detection component 314 detects an event associated with a product item. For example, in some examples, the event detection component 314 may obtain sensor output from a lane sensor associated with a merchandiser device and/or image data from an imaging device associated with a merchandiser device. In some examples, the event detection component 314 may detect an event associated with a product item that is brought near a merchandiser device such as a self-service kiosk. In some examples, the event detection component 314 may detects an event associated with a product item stored in a lane of a storage component of a merchandiser device based on sensor output produced by a lane sensor (e.g., a time-of-flight sensor) positioned for use with that lane. The event may, for example, correspond to one of a product item being retrieved from the merchandiser device (i.e., from the lane associated with the lane sensor from which the sensor output is received) or a product item being placed (e.g., replaced) within the merchandiser device (i.e., within the lane associated with the lane sensor from which the sensor output is received). The sensor output indicates a change in distance between the lane sensor and a closest product item to the lane sensor in the lane. The event detection component 314 can detect an event corresponding to a product item being retrieved from the merchandiser device based on the sensor output indicating that a distance between the lane sensor and a closest product item to the lane sensor in the lane has increased, such as compared to a previously determined distance therebetween. The event detection component 314 can detect an event corresponding to a product item being placed within the merchandiser device based on the sensor output indicating that a distance between the lane sensor and a closest product item to the lane sensor in the lane has decreased, such as compared to a previously determined distance therebetween. Thus, the event detection component 314 may use a previously determined distance between the subject lane sensor and the closest product item to the lane sensor in the subject lane to determine whether the event is a product retrieval event or a product replacement event.

The product identification component 316 determines identifying information associated with a product item. For example, the product identification component 316 may determine product identifying information for a product item associated with the event detected by the event detection component 314. In some examples, the product identification component 316 may be configured to obtain image data via an imaging device associated with a merchandiser device. The product identification component 316 may determine identifying information (e.g., a product type and/or a specific product identity) of a product item based on the image data. For example, the product identification component 316 may receive a computer vision component from the product management software 302 and may determine a product type of a product item using the computer vision component and based on the image data. Additionally, or alternatively, the product identification component 316 may be configured to process sensor output to determine a lane of the merchandiser device with which the lane sensor is mapped. The product identification component 316 may access information associated with the planogram of the merchandiser device and process that information to determine the identifying information for the product item based on product information associated with the lane with which the lane sensor is mapped.

The quantity determination component 318 determines a quantity of the product item associated with the event detected by the event detection component 314. For example, the quantity determination component 318 may determine the quantity of the product item based on the image data (e.g., using the computer vision component), the sensor output produced by the lane sensor, and/or dimensional information associated with the product item. For example, where the lane sensor is a time-of-flight sensor, the sensor output indicates a distance between the lane sensor and a nearest surface (i.e., a surface of a product item closest to the lane sensor within the lane). The distance indicated by the sensor output can be compared against a previously determined distance between the lane sensor and that product item closest to the lane sensor within the lane to determine a delta. The quantity determination component 318 accesses information associated with the product item determined by the product identification component 316 to determine dimensional (e.g., depth) information for the product item. The delta is divided by the dimensional information for the product to determine a number of product items which were associated with the event (e.g., a number of product items retrieved from the lane or placed within the lane).

In some implementations, the quantity determination component 318 may determine a quantity of the product associated with the event based on the image data and/or sensor output without dimensional information. For example, the image data and/or sensor output may be produced by one or more imaging devices and/or lane sensors above or below the product items within the lane (e.g., multiple time-of-flight sensors included in a time-of-flight sensor strip downwardly facing the multiple product items stored in the lane from a top surface of the lane or upwardly facing the multiple product items stored in the lane from a bottom surface of the lane). In such a case, each of the lane sensors may be positioned over or under a location of a product item within the lane. The image data and/or sensor output from a given one of those imaging devices and/or lane sensors may indicate a value different from one expected when a product is in the location above or below the imaging device and/or lane sensor. For example, a time-of-flight sensor above a product item before the event may produce sensor output indicating that a distance from the time-of-flight sensor to a nearest surface (i.e., the top surface of the product item) is a first distance. Where that product item is retrieved from the merchandiser device as part of the detected event, the time-of-flight sensor may now produce output indicating that the distance from the time-of-flight sensor to the nearest surface (i.e., the bottom of the lane) is a second distance which is greater than the first distance. The number of lane sensors for which the second distance is determined based on the sensor output may be counted and inferred as the quantity of the product items associated with the event where the event corresponds to a product retrieval. The opposite is true for events corresponding to product replacements. For example, a time-of-flight sensor above a product item before the event may produce sensor output indicating that a distance from the time-of-flight sensor to a nearest surface (i.e., the bottom of the lane) is a first distance. Where that product item is retrieved from the merchandiser device as part of the detected event, the time-of-flight sensor may now produce output indicating that the distance from the time-of-flight sensor to the nearest surface (i.e., the top surface of the product item) is a second distance which is less than the first distance. The number of lane sensors for which the second distance is determined based on the sensor output may be counted and inferred as the quantity of the product item associated with the event where the event corresponds to a product placement. In some examples, the quantity determination component 318 may use image data to verify one or more quantity determinations made based on lane sensor output.

The output generation component 320 outputs data configured to cause an update to an inventory record associated with a product item based on the identifying information determined by the product identification component 316 and based on the quantity determined by the quantity determination component 318. In particular, the data generated by the output generation component 320 can be used to decrease an inventory record associated with the subject product by the determined quantity where the event corresponds to a product retrieval or to increase an inventory record associated with the subject product by the determined quantity where the event corresponds to a product placement. In some cases, the data generated by the output generation component 320 may automatically update the inventory record associated with the product item (e.g., by providing the data to the inventory management software 306). In some cases, the data generated by the output generation component 320 may be indicated to a device (e.g., the operator device 162 or the management device 164 shown in FIG. 1) to cause a user thereof to manually update the inventory record associated with the product.

In some implementations, the output generation component 320 can output data indicative of a state of a merchandising device corresponding to a given event. States of the merchandising device can refer to a degree to which a lane is stocked (e.g., empty, partially stocked, or fully stocked) and/or a number of product items remaining stocked in the lane. For example, a first distance between a front of a lane and a lane sensor of the lane may be registered (e.g., when calibrating or installing the lane sensor) and recognized as a distance indicating that the lane is empty. Similarly, a second distance between a last product item and the lane sensor may be registered (e.g., after stocking the lane) and recognized as a distance indicating that the lane is fully stocked. Thus, a distance measured in connection with an event that is between the first distance and the second distance may be recognized as a distance indicating that the lane is partially stocked. Where a distance measured based on an event corresponding to a product retrieval is equal to the first distance, the output generation component 320 may indicate an empty state of the lane to a receiving device. Where a distance measured based on an event corresponding to a product retrieval or a product replacement is between the first distance and the second distance, the output generation component 320 may indicate a partially stocked state of the lane to a receiving device. Where a distance measured based on an event corresponding to a product replacement is equal to the second distance, the output generation component 320 may indicate a full state of the lane to a receiving device. In some examples, the output generation component 320 may use the computer vision component to determine, based on image data, a state of a merchandising device corresponding to a given event.

In some such implementations, the output generation component 320 may maintain a state indicative of the number of product items remaining stocked in the lane corresponding to an event. For example, the output generation component 320 may monitor and update, based on each event, a number of the product item stocked in the lane, in which the number of product items increases with each event corresponding to a product replacement and decreases with each event corresponding to a product retrieval. For example, for each event, the output generation component 320 may increment a current count of the product item associated with the lane by the quantity of product items determined by the quantity determination component 318. The data indicative of a state of a lane of the merchandising device corresponding to a given event can be transmitted (e.g., as an alert) to one or more devices, for example, the operator device 162 and/or the management device 164.

In some implementations, the output generation component 320 may generate and output an alert associated with a forecasted inventory event associated with the product item corresponding to a given event. For example, an inventory event associated with the product item may be forecasted based on the event detected by the event detection component 314 and based on one or more historical events associated with the lane. An alert associated with the forecasted inventory event may then be output to a device (e.g., the operator device 162) associated with the merchandiser device.

In some implementations, the product event processing software 304 may include functionality for generating and/or updating a planogram of the merchandiser device associated with the event. For example, after the merchandiser device is stocked for a first time, the planogram thereof may be generated. Generating the planogram for the merchandiser device can include using an image depicting the stocked merchandiser device to identify product items in each of the lanes of each of the rows of the storage area of the merchandiser device. For example, object detection and recognition processes (e.g., using the computer vision component) can be performed against the image depicting the stocked merchandiser device to identify the product items therein. In another example, manual user input specifying the product items and their locations within lanes of the rows of the storage area of the merchandiser device may be used to generate the planogram. In another example, at some point after the planogram is generated, the planogram may be updated. For example, the planogram may be updated based on a restocking of products in the planogram. Updating the planogram can include using an image depicting the restocked merchandiser device to identify product items in each of the lanes of each of the rows of the storage area of the merchandiser device. For example, object detection and recognition processes (e.g., using the computer vison component) can be performed against the image depicting the restocked merchandiser device to identify the product items therein. In another example, manual user input specifying the product items and their locations within lanes of the rows of the storage area of the merchandiser device after a restocking thereof may be used to update the planogram. In yet another example, where sensor strips are used within lanes of the merchandiser device (e.g., coupled to a top or bottom surface of each lane), the lane sensors of a given sensor strip can determine dimensional information for the product items in the lane and compare that dimensional information to dimensional information known to the current planogram. For example, where the lane sensors are time-of-flight sensors, the dimensional information determined by the lane sensors of a sensor strip within a lane can indicate a distance between the lane sensors and the products above or below them. Those distances can be compared against the distances that should be determined based on the dimensional information stated in the planogram. In the event of a mismatch, the mismatch can be flagged to an operator (e.g., via an alert transmitted to the operator device 162) to cause the operator to review the planogram for potential updates. In some examples, a combination of image data, lane sensor output, and/or manual input may be used to update a planogram.

The transaction control component 322 may facilitate completion of a transaction associated with a product item identified by the product identification component 316. For example, in some examples, the transaction control component 322 may include functionality for updating an account associated with a consumer causing the event by an amount based on the identifying information for the product item and the quantity of the product item. For example, an account associated with a consumer causing the event may be determined by the product event processing software 304. Determining the account associated with the consumer may include performing facial recognition against images captured external to the merchandiser device (e.g., by a camera coupled to a front of the merchandiser device and pointing away from the merchandiser device) to determine a face of the consumer which may then be matched against an account associated with an operator or other service provider of the merchandiser device. Alternatively, determining the account associated with the consumer may include using information communicated from a consumer device of the consumer in connection with the event (e.g., a message transmitted from the consumer device to a computing device of the merchandiser device or to a server device based on a scanning, by a camera of the consumer device, of a product item retrieved from or placed within the merchandiser) to identify the consumer. Based on the event, the account determined as being associated with the consumer may be automatically updated by the transaction control component 322 by an amount based on the identifying information and quantity. For example, where the event corresponds to the product item being retrieved from the merchandiser device, the update corresponds to a charge to the account. In another example, where the event corresponds to the product item being placed within the merchandiser device, the update corresponds to a refund to the account.

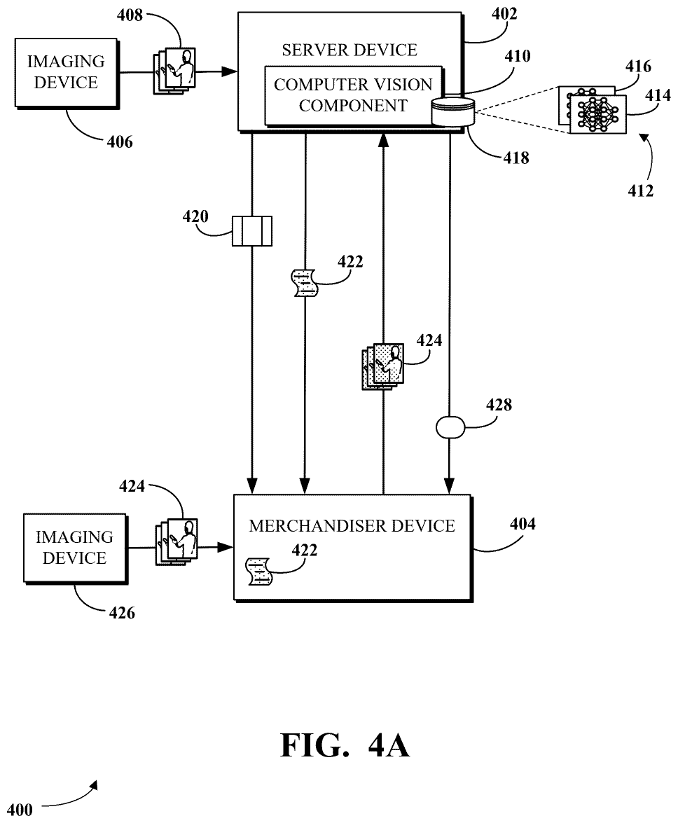

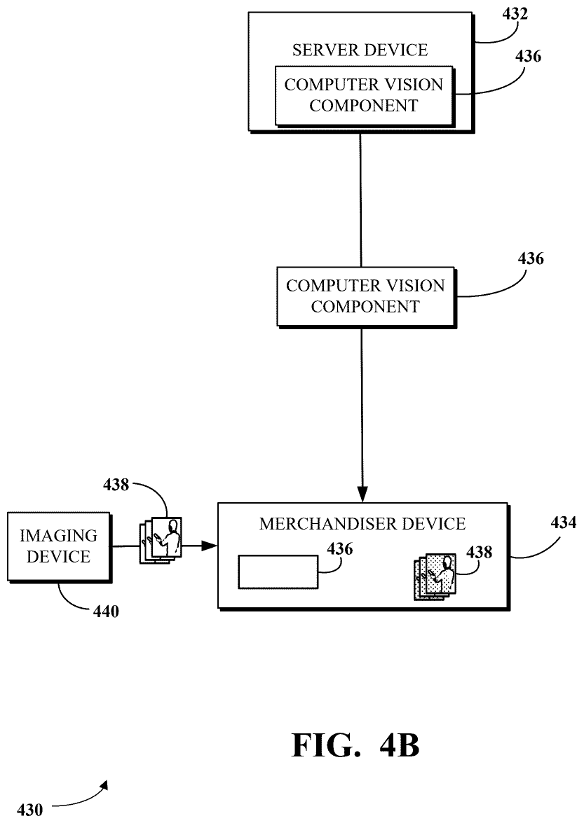

FIG. 4A is a schematic block diagram illustrating operations of an example of a self-service retail market system 400 in accordance with the present disclosure. The self-service retail market system 400 may be, be similar to, include, or be included in, the self-service retail market system 300 shown in FIG. 3 and/or the self-service retail market system 100 shown in FIG. 1. As shown, the self-service retail market system 400 includes a server device 402 and a merchandiser device 404. The server device 402 may be, be similar to, include, or be included in, the server device 134 shown in FIG. 1. Product management software (e.g., the product management software 302 shown in FIG. 3) may be implemented at the server device 402. The merchandiser device 404 may be, be similar to, include, or be included in, the merchandiser device 102 shown in FIG. 1. Product event processing software (e.g., the product event processing software 304 shown in FIG. 3) may be implemented at the merchandiser device 404.

As shown, the server device 402 may obtain, via an imaging device 406 (e.g., an imaging device associated with a picking station for inventory order fulfillment), first image data 408 corresponding to a first product item having a product type. The first image data may be associated with a bin-packing operation in which the first product item is removed from a storage component of the picking station and placed in a stocking bin associated with a self-service retail market environment. The first image data may correspond to one or more images of a packer holding the first product item. The server device 402 may determine, in association with the picking station, the product type. For example, the server device 402 may obtain a storage component identifier corresponding to the storage component and access a database that includes a stored indication of an association between the storage component identifier and the product type identifier.

The server device 402 may generate, using at least the first image data 408, a computer vision component 410 associated with at least the product type. To generate the computer vision component 410, the server device may train one or more computer vision model 412 using at least the first image data and a product type identifier corresponding to the product type. In some implementations, the one or more computer vision models 412 may include a “global” or “general” computer vision model 414 that can be used in connection with any number of different merchandiser devices 404. The one or more computer vision models 412 may include a localized computer vision model 416 that may be associated with a particular merchandiser device 404 and/or a particular self-service retail market environment (which may include a number of merchandiser devices 404). The server device 402 may store the computer vision models 412 in a memory 418 associated with the server device 402.

The server device 402 may generate a planogram 420 based at least in part on the computer vision component 410 and provide the planogram to the merchandiser device 404. The server device 402 may provide the computer vision component 410 for use with the merchandiser device 404. For example, as shown in FIG. 4A, to provide the computer vision component 410 for use with the merchandiser device 404, the server device 402 may provide, to the merchandiser device 404, a program component 422 associated with the computer vision component 410. The merchandiser device 404 may store the program component 422. The program component 422 may include instructions that may be processed by the merchandiser device 404 to cause the merchandiser device 404 to obtain second image data 424 from an imaging device 426 associated with the merchandiser device 404. In some examples, the program component 422 may include any number of different types of information associated with obtaining the second image data 424 such as, for example, imaging parameters, storage instructions, encoding instructions, transmission instructions, and/or the like.

The merchandiser device 404 may obtain the second image data 424 via the imaging device 426. The merchandiser device 404 may provide, to the server device, the second image data 424 (and/or derived data that is based on the second image data). For example, the merchandiser device 404 may provide the second image data 424 and/or derived data to the server device in accordance with instructions included in the program component 422. The server device 402 may determine, based on the second image data 424 and/or derived data, a product type of a product item pictured in the second image data. The server device 402 may provide, to the merchandiser device 404, an indication 428 of the product type (and/or data indicative of the product type or a transaction type corresponding to the product type) based on the determination of the product type. The merchandiser device 404 may facilitate completion of a transaction associated with the product item based on the indication 428.

FIG. 4B is a schematic block diagram illustrating operations of another example of a self-service retail market system 430 in accordance with the present disclosure. The self-service retail market system 430 may be, be similar to, include, or be included in, the self-service retail market system 400 shown in FIG. 4A, the self-service retail market system 300 shown in FIG. 3 and/or the self-service retail market system 100 shown in FIG. 1. As shown, the self-service retail market system 430 includes a server device 432 and a merchandiser device 434. The server device 432 may be, be similar to, include, or be included in, the server device 402 shown in FIG. 4A and/or the server device 134 shown in FIG. 1. Product management software (e.g., the product management software 302 shown in FIG. 3) may be implemented at the server device 432. The merchandiser device 434 may be, be similar to, include, or be included in, the merchandiser device 404 shown in FIG. 4A and/or the merchandiser device 102 shown in FIG. 1. Product event processing software (e.g., the product event processing software 304 shown in FIG. 3) may be implemented at the merchandiser device 434.

The operations of the self-service retail market system 430 may be similar to the operations of the self-service retail market system 400 with the exception that, in the self-service retail market system 430, rather than providing a program component 422 to the merchandiser device 434, the server device 432 provides, to the merchandiser device 434, a computer vision component 436 (or one or more aspects thereof) or an instance of the computer vision component 436, as shown. In this way, the merchandiser device 434 may receive second image data 438 via an imaging device 440 and may determine, using the computer vision component 436, a product type associated with a product item shown in the second image data 438 (e.g., to facilitate a transaction corresponding thereto).

As described above in connection with FIGS. 1-4B, various implementations of the disclosure relate to using computer vision for product identification in association with self-service retail market environments. To further describe some implementations in greater detail, reference is next made to examples of techniques used by a self-service retail market system. The techniques may be executed using one or more computing devices, such as included within or otherwise using the systems, software, and devices described with respect to FIGS. 1-4B. The techniques may be performed, for example, by executing computer-executable instructions such as routines, instructions, or programs described according to Java, JavaScript, C++, or other such routines or instructions. The steps, or operations, of the techniques or any other technique, method, process, or algorithm described in connection with implementations disclosed herein may be implemented directly in hardware, firmware, software executed by hardware, circuitry, or a combination thereof.

Although the techniques are each shown as a series of operations for clarity, implementations of those techniques or any other method, technique, process, and/or algorithm described in connection with the implementations disclosed herein can be performed in various orders and/or concurrently, unless a particular order of operation is specified herein. Additionally, operations in accordance with this disclosure may be performed with other operations not presented and described herein. Furthermore, one or more aspects of the systems and techniques described herein may be omitted.

FIG. 5 is a flowchart illustrating a first example of a technique 500 for using computer vision for product identification in association with a self-service retail market environment. The example technique 500 is an example in which a computing device (e.g., the computing device 200 depicted in FIG. 2) performs operations associated with using computer vision for product identification in association with a self-service retail market environment. As shown by reference number 502, the technique 500 may include obtaining first image data corresponding to a first product item having a product type. For example, the computing device (such as by using the product management software 302 depicted in FIG. 3) may obtain, via an imaging device associated with a picking station for inventory order fulfillment, first image data corresponding to a first product item having a product type, as described above in connection with FIG. 3. In some implementations, the first image data is associated with a bin-packing operation in which the first product item is removed from a storage component of the picking station and placed in a stocking bin associated with the self-service retail market environment, the first image data corresponding to one or more images of a packer holding the first product item.

As shown by reference number 504, the technique 500 may include determining, in association with the picking station, the product type. For example, the computing device (such as by using the product management software 302 depicted in FIG. 3) determine, in association with the picking station, the product type, as described above in connection with FIG. 3. In some implementations, determining the product type may include obtaining a storage component identifier corresponding to the storage component and accessing a database comprising a stored indication of an association between the storage component identifier and the product type identifier. In some implementations, the product type identifier includes an SKU. In some implementations, the imaging device includes one or more cameras, wherein each of the one or more cameras has a respective orientation relative to the picking station.

As shown by reference number 506, the technique 500 may include generating a computer vision component. For example, the computing device (such as by using the product management software 302 depicted in FIG. 3) generate, using at least the first image data, a computer vision component associated with at least the product type, wherein the processing system, to generate the computer vision component, is configured to cause the apparatus to train a computer vision model using at least the first image data and a product type identifier corresponding to the product type, as described above in connection with FIG. 3. In some implementations, generating the computer vision component may include obtaining, via the imaging device, third image data corresponding to a third product item having an additional product type and training the computer vision model based at least in part on the third image data.

In some implementations, the computer vision model includes a localized model associated with the merchandiser device. In some implementations, the imaging device includes one or more cameras, and at least one of the one or more cameras has an orientation that corresponds to an orientation of a merchandiser camera associated with the merchandiser device. In some implementations, the imaging device includes a first camera, and a first illumination device associated with the camera has an orientation that corresponds to an orientation of a second illumination device associated with a second camera, where the second camera is associated with the merchandiser device. In some implementations, the technique 500 further includes generating, based at least in part on the computer vision model, a first planogram associated with the merchandiser device.

As shown by reference number 508, the technique 500 may include providing the computer vision component for use with a merchandiser device. For example, the computing device (such as by using the product management software 302 depicted in FIG. 3) provide the computer vision component for use with a merchandiser device, as described above in connection with FIG. 3.

The technique 500 may include additional aspects (e.g., additional operations and/or features), such as any single aspect or any combination of aspects described below or in connection with one or more other techniques described elsewhere herein.

FIG. 6 is a flowchart illustrating a second example of a technique 600 for using computer vision for product identification in association with a self-service retail market environment. The example technique 600 is an example in which a computing device (e.g., the computing device 200 depicted in FIG. 2) performs operations associated with using computer vision for product identification in association with a self-service retail market environment. As shown by reference number 602, the technique 600 may include obtaining first image data corresponding to a first product item having a product type. For example, the computing device (such as by using the product management software 302 depicted in FIG. 3) may obtain, via an imaging device associated with a picking station for inventory order fulfillment, first image data corresponding to a first product item having a product type, as described above in connection with FIG. 3.

As shown by reference number 604, the technique 600 may include generating a computer vision component. For example, the computing device (such as by using the product management software 302 depicted in FIG. 3) may generate, using at least the first image data, a computer vision component associated with at least the product type, wherein generating the computer vision component includes training a computer vision model using at least the first image data and a product type identifier corresponding to the product type, as described above in connection with FIG. 3.

In some implementations, generating the computer vision component includes receiving, from a computing device associated with the picking station, labeling data indicative of the product type identifier and associating the product type identifier with the first image data. In some implementations, the labeling data includes a storage component identifier corresponding to a storage component of the picking station from which the first product item is removed, and the technique 600 further includes determining the product type identifier using a database comprising a stored indication of an association between the storage component identifier and the product type identifier. In some implementations, the labeling data includes the product type identifier.

In some implementations, the first image data is associated with a bin-packing operation in which the first product item is removed from a storage component of the picking station and placed in a stocking bin associated with the self-service retail market environment, the first image data corresponding to one or more images of a packer holding the first product item. In some implementations, the technique 600 further includes determining, based on at least one of the first image data or third image data corresponding to the first product item, that the first item has been placed in the stocking bin; and providing, to an inventory management system associated with the merchandiser device, an inventory indication corresponding to the first product item. In some implementations, the technique 600 further includes generating, based at least in part on the first computer vision model, a first planogram associated with the merchandiser device.

As shown by reference number 606, the technique 600 may include providing the computer vision component for use with a merchandiser device. For example, the computing device (such as by using the product management software 302 depicted in FIG. 3) provide the computer vision component for use with a merchandiser device, as described above in connection with FIG. 3.

The technique 600 may include additional aspects (e.g., additional operations and/or features), such as any single aspect or any combination of aspects described below or in connection with one or more other techniques described elsewhere herein.

FIG. 7 is a flowchart illustrating an example of a technique 700 for using computer vision for product identification in association with a product transaction at a self-service retail market environment. The example technique 700 is an example in which a computing device (e.g., the computing device 200 depicted in FIG. 2) performs operations associated with using computer vision for product identification in association with a self-service retail market environment. As shown by reference number 702, the technique 700 may include obtaining a computer vision component. For example, the computing device (such as by using the product event processing software 304 depicted in FIG. 3) may obtain a computer vision component, wherein the computer vision component is based on a computer vision model trained using first image data associated with a bin-packing operation in which a first product item, having a product type, is removed from a picking station and placed in a stocking bin associated with the self-service retail market environment, the first image data corresponding to one or more images of a packer holding the first product item, as described above in connection with FIG. 3.

As shown by reference number 704, the technique 700 may obtain second image data associated with a second product item. For example, the computing device (such as by using the product event processing software 304 depicted in FIG. 3) may obtain, via a merchandiser imaging device comprising at least one merchandiser camera, second image data associated with a second product item, as described above in connection with FIG. 3. In some implementations, the at least one merchandiser camera has an orientation that corresponds to an orientation of a warehouse camera associated with the picking station. In some implementations, a first illumination device has an orientation with respect to the at least one merchandiser camera that corresponds to an orientation of second illumination device associated with a warehouse camera of the picking station.

As shown by reference number 706, the technique 700 may include determining that the second product item has the product type. For example, the computing device (such as by using the product event processing software 304 depicted in FIG. 3) may determine, using the computer vision component and based at least in part on the second image data, that the second product item has the product type, as described above in connection with FIG. 3.

As shown by reference number 708, the technique 700 may include facilitating a product transaction operation based on determining that the second product item has the product type. For example, the computing device (such as by using the product event processing software 304 depicted in FIG. 3) facilitate a product transaction operation based on determining that the second product item has the product type, as described above in connection with FIG. 3.

The technique 700 may include additional aspects (e.g., additional operations and/or features), such as any single aspect or any combination of aspects described below or in connection with one or more other techniques described elsewhere herein.

The implementations of this disclosure can be described in terms of functional block components and various processing operations. Such functional block components can be realized by any number of hardware and/or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the systems and techniques can be implemented with any programming or scripting language, such as C, C++, Java, JavaScript, assembler, or the like, with the various algorithms being implemented with any combination of data structures, objects, processes, routines, or other programming elements.

Functional aspects can be implemented in algorithms that execute on one or more processors. Furthermore, the implementations of the systems and techniques could employ any number of conventional techniques for electronics configuration, signal processing or control, data processing, and the like. The words “mechanism” and “element” are used broadly and are not limited to mechanical or physical implementations, but can include software routines in conjunction with processors, etc.

Likewise, the terms “mechanism,” “module,” or “monitor” as used herein and in the figures may be understood as corresponding to a functional unit implemented using software, hardware (e.g., an integrated circuit, such as an application-specific integrated circuit (ASIC)), or a combination of software and hardware. In certain contexts, such mechanisms, modules, or monitors may be understood to be a processor-implemented software mechanism, processor-implemented software module, or software-implemented monitor that is part of or callable by an executable program, which may itself be wholly or partly composed of such linked mechanisms, modules, or monitors.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While this disclosure has been described in connection with certain implementations, it is to be understood that this disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus for using computer vision for product identification in association with a self-service retail market environment, the apparatus comprising:
a processing system that includes one or more memories and one or more processors coupled with the one or more memories, the processing system configured to cause the apparatus to:
obtain, via an imaging device associated with a picking station for inventory order fulfillment, first image data corresponding to a first product item having a product type;
determine, in association with the picking station, the product type;
generate, using at least the first image data, a computer vision component associated with at least the product type, wherein the processing system, to cause the apparatus to generate the computer vision component, is configured to cause the apparatus to train a computer vision model using at least the first image data and a product type identifier corresponding to the product type; and
provide the computer vision component for use with a merchandiser device, wherein the computer vision component is configured to facilitate, based on second image data, identification of a second product item having the product type.

2. The apparatus of claim 1, wherein the first image data is associated with a bin-packing operation in which the first product item is removed from a storage component of the picking station and placed in a stocking bin associated with the self-service retail market environment, the first image data corresponding to one or more images of a packer holding the first product item.

3. The apparatus of claim 2, wherein the processing system, to cause the apparatus to determine the product type, is configured to cause the apparatus to:
obtain a storage component identifier corresponding to the storage component; and
access a database comprising a stored indication of an association between the storage component identifier and the product type identifier.

4. The apparatus of claim 1, wherein the product type identifier comprises a stock keeping unit (SKU).

5. The apparatus of claim 1, wherein, to cause the apparatus to train the computer vision model, the processing system is further configured to:
cause the apparatus to obtain, via the imaging device, third image data corresponding to a third product item having an additional product type; and
train the computer vision model based at least in part on the third image data.

6. The apparatus of claim 1, wherein the imaging device comprises one or more cameras, wherein each of the one or more cameras has a respective orientation relative to the picking station.

7. The apparatus of claim 1, wherein the computer vision model comprises a localized model associated with the merchandiser device.

8. The apparatus of claim 7, wherein the imaging device comprises one or more cameras, and wherein at least one of the one or more cameras has an orientation that corresponds to an orientation of a merchandiser camera associated with the merchandiser device.

9. The apparatus of claim 7, wherein the imaging device comprises a first camera, wherein a first illumination device associated with the camera has an orientation that corresponds to an orientation of a second illumination device associated with a second camera, and wherein the second camera is associated with the merchandiser device.

10. The apparatus of claim 1, wherein the processing system is further configured to cause the apparatus to generate, based at least in part on the computer vision model, a first planogram associated with the merchandiser device.

11. A method for using computer vision for product identification in association with a self-service retail market environment, the method comprising:
obtaining, via an imaging device associated with a picking station for inventory order fulfillment, first image data corresponding to a first product item having a product type;
generating, using at least the first image data, a computer vision component associated with at least the product type, wherein generating the computer vision component comprises training a computer vision model using at least the first image data and a product type identifier corresponding to the product type; and
providing the computer vision component for use with a merchandiser device, wherein the computer vision component is configured to facilitate, based on second image data, identification of a second product item having the product type.

12. The method of claim 11, wherein training the computer vision component comprises:
receiving, from a computing device associated with the picking station, labeling data indicative of the product type identifier; and
associating the product type identifier with the first image data.

13. The method of claim 12, wherein the labeling data comprises a storage component identifier corresponding to a storage component of the picking station from which the first product item is removed, the method further comprising determining the product type identifier using a database comprising a stored indication of an association between the storage component identifier and the product type identifier.

14. The method of claim 12, wherein the labeling data comprises the product type identifier.

15. The method of claim 11, further comprising generating, based at least in part on the computer vision model, a first planogram associated with the merchandiser device.

16. The method of claim 11, wherein the first image data is associated with a bin-packing operation in which the first product item is removed from a storage component of the picking station and placed in a stocking bin associated with the self-service retail market environment, the first image data corresponding to one or more images of a packer holding the first product item.

17. The method of claim 16, further comprising:
determining, based on at least one of the first image data or third image data corresponding to the first product item, that the first product item has been placed in the stocking bin; and
providing, to an inventory management system associated with the merchandiser device, an inventory indication corresponding to the first product item.

18. A merchandiser device for using computer vision for product identification in association with a self-service retail market environment, the merchandiser device comprising:
a processing system that includes one or more memories and one or more processors coupled with the one or more memories, the processing system configured to cause the merchandiser device to:
obtain a computer vision component, wherein the computer vision component is based on a computer vision model trained using first image data associated with a bin-packing operation in which a first product item, having a product type, is removed from a picking station and placed in a stocking bin associated with the self-service retail market environment, the first image data corresponding to one or more images of a packer holding the first product item;
obtain, via a merchandiser imaging device comprising at least one merchandiser camera, second image data associated with a second product item;
determine, using the computer vision component and based at least in part on the second image data, that the second product item has the product type; and
facilitate a product transaction operation based on determining that the second product item has the product type.

19. The merchandiser device of claim 18, wherein the at least one merchandiser camera has an orientation that corresponds to an orientation of a warehouse camera associated with the picking station.

20. The merchandiser device of claim 18, further comprising a first illumination device associated with the at least one merchandiser camera, wherein the first illumination device has an orientation with respect to the at least one merchandiser camera that corresponds to an orientation of second illumination device associated with a warehouse camera of the picking station.
